(19) United States
(12) Patent Application Publication
(10) Pub. No.: US 2018/0108103 A1
(43) Pub. Date: Apr. 19, 2018

(54) SYSTEMS AND METHODS FOR MATCHING AND DISPLAYING SERVICE REQUEST AND AVAILABLE VEHICLES

(71) Applicant: BEIJING DIDI INFINITY TECHNOLOGY AND DEVELOPMENT CO., LTD., Beijing (CN)

(72) Inventors: Junqin Li, Beijing (CN); Guojiao Tai, Beijing (CN); Zhenghua Wu, Beijing (CN); Zhongyu Cao, Beijing (CN); Xinrui Li, Beijing (CN); Yang Zhou, Beijing (CN)

(73) Assignee: BEIJING DIDI INFINITY TECHNOLOGY AND DEVELOPMENT CO., LTD., Beijing (CN)

(21) Appl. No.: 15/821,876

(22) Filed: Nov. 24, 2017

Related U.S. Application Data
(63) Continuation of application No. PCT/CN2016/113890, filed on Dec. 30, 2016.

(30) Foreign Application Priority Data
Jan. 27, 2016 (CN) 201610056723.2
Mar. 24, 2016 (CN) 201610176539.1

(51) Int. Cl. G06Q 50/30; G06F 17/30; G08G 1/00; G06Q 10/06

(52) U.S. Cl. CPC G06Q 50/30; G06F 17/30241; G06Q 10/02; G06Q 10/06315; G06Q 10/063112; G08G 1/202

(57) ABSTRACT

A method for monitoring on route transportations includes obtaining, from a first passenger terminal, a transportation service request for a transportation service including a pickup location and a drop-off location; before selecting a vehicle to provide the transportation service: obtaining status information of a plurality of vehicles from a plurality of driver terminals within a first predetermined region around the pickup location, wherein each of the plurality of vehicles corresponds to a driver terminal of the plurality of driver terminals; determining from the plurality of vehicles, at least one candidate vehicle available to provide the transportation service based on the status information of the plurality of vehicles; and sending a real-time position of each of the at least one candidate vehicle to the first passenger terminal to display a tag of the at least one candidate vehicle in an electronic map on the first passenger terminal.

### CROSS-REFERENCE TO RELATED APPLICATIONS

This application is a continuation of International Application No. PCT/CN2016/113890, filed on Dec. 30, 2016, which claims priority of Chinese Patent Application No. 201610056723.2 filed on Jan. 27, 2016, and Chinese Patent Application No. 201610176539.1 filed on Mar. 24, 2016, the entire contents of each of which are hereby incorporated by reference.

### TECHNICAL FIELD

This application relates generally to management of on-demand services. Specifically, the present disclosure relates to matching and displaying service requests and available vehicles.

### BACKGROUND

On-demand services, such as transportation service, hailing services, are commonly used in people's daily life. When a service requestor sends out a service request for a transportation service, he or she may desire to know information related to vehicles available to provide the transportation service for him or her, such as the number of the available vehicles, the position of the available vehicles, or other information regarding the available vehicles. In some situations the demand for transportation services may exceed the service supply, an online transformation service platform may offer a service with a raised service price. The service requestor may desire to know why and how the price is raised. Hence, there is a need to provide related information to the service requestor to improve user experience and enhance the sense of trust of users.

### SUMMARY

A first aspect of the present disclosure relates to a system for matching a transportation service request and candidate vehicles. The system may include at least one processor and a computer-readable storage medium storing a first set of instructions for monitoring a target vehicle. When executing the first set of instructions, the at least one processor is directed to: obtain, from a first passenger terminal, a transportation service request for a transportation service including a pickup location and a drop-off location; before selecting a vehicle to provide the transportation service, the at least one processor is directed to: obtain status information of a plurality of vehicles from a plurality of driver terminals within a first predetermined region around the pickup location, wherein each of the plurality of vehicles corresponds to one driver terminal of the plurality of driver terminals; determine, from the plurality of vehicles, at least one candidate vehicle available to provide the transportation service based on the status information of the plurality of vehicles; and send a real-time position of each of the at least one candidate vehicle to the first passenger terminal to display a tag of the at least one candidate vehicle in an electronic map on the first passenger terminal.

A second aspect of the present disclosure relates to a method for matching a transportation service request and candidate vehicles. The method may include: obtaining, from a first passenger terminal, a transportation service request for a transportation service including a pickup location and a drop-off location; before selecting a vehicle to provide the transportation service, the method may further include: obtaining status information of a plurality of vehicles from a plurality of driver terminals within a first predetermined region around the pickup location, wherein each of the plurality of vehicles corresponds to one driver terminal of the plurality of driver terminals; determining from the plurality of vehicles, at least one candidate vehicle available to provide the transportation service based on the status information of the plurality of vehicles; and sending a real-time position of each of the at least one candidate vehicle to the first passenger terminal to display a tag of the at least one candidate vehicle in an electronic map on the first passenger terminal.

A third aspect of the present disclosure relates to a system for displaying a number of transportation service requests. The system may include at least one processor and a computer-readable storage medium storing a second set of instructions for monitoring a target vehicle. When executing the second set of instructions, the at least one processor is directed to: obtain from a passenger terminal, a transportation service request for a transportation service including a pickup location; determine a number of transportation service requests within a predetermined region of the pickup location; determine a number of candidate vehicles within the predetermined region; and send the number of transportation service requests and the number of candidate vehicles to the passenger terminal to display the number of transportation service requests and the number of candidate vehicles in text or graphic view on the passenger terminal.

A fourth aspect of the present disclosure relates to a method for displaying a number of transportation service requests. The method may include obtaining, from a passenger terminal, a transportation service request for a transportation service including a pickup location; determining a number of transportation service requests within a predetermined region of the pickup location; determining a number of candidate vehicles within the predetermined region; and sending the number of transportation service requests and the number of candidate vehicles to the passenger terminal to display the number of transportation service requests and the number of candidate vehicles in text or graphic view on the passenger terminal.

A fifth aspect of the present disclosure relates to a system for displaying information related to transportation services. The system may include at least one processor and a computer-readable storage medium storing a fifth set of instructions for displaying information related to transportation services. When executing the fifth set of instructions, the at least one processor is directed to: send a transportation service request for a transportation service including a pickup location to at least one computer server of an online transportation service platform; receive, from the online transportation service platform, information of at least one other transportation service request within a predetermined region of the pickup location; receive, from the online transportation service platform, information of at least one candidate vehicle available to provide the transportation service; and display the information of the at least one other transportation service request and the information of the at least one candidate vehicle.

A sixth aspect of the present disclosure relates to a method for displaying information related to transportation services. The method includes sending a transportation service request for a transportation service including a pickup location to at least one computer server of an online transportation service platform; receiving, from the online transportation service platform, information of at least one other transportation service request within a predetermined region of the pickup location; receiving, from the online transportation service platform, information of at least one candidate vehicle available to provide the transportation service; and displaying the information of the at least one other transportation service request and the information of the at least one candidate vehicle.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary on-demand service system according to some embodiments of the present disclosure;

FIG. 2 is a schematic diagram illustrating exemplary hardware and software components of a computing device on which the server, the requestor terminal, and/or the provider terminal may be implemented according to some embodiments of the present disclosure;

FIG. 3 is a block diagram illustrating an exemplary processing engine according to some embodiments of the present disclosure;

FIG. 4 is a flowchart of an exemplary method and/or process for determining candidate vehicle(s) based on a transportation service request according to some embodiments of the present disclosure;

FIG. 5 is a flowchart of an exemplary method and/or process for determining candidate vehicle(s) based on a transportation service request and status information of vehicle(s);

FIG. 6 is a flowchart of an exemplary method and/or process for displaying information related to candidate vehicle(s) in an user interface of a passenger terminal according to some embodiments of the present disclosure;

FIG. 7 is a flowchart of an exemplary method and/or process for determining status information in a driver terminal according to some embodiments of the present disclosure;

FIG. 8 is a flowchart of an exemplary method and/or process for adjusting a price for a transportation service according to some embodiments of the present disclosure;

FIG. 9 is a flowchart of an exemplary method and/or process for displaying a price adjustment request in a passenger terminal according to some embodiments of the present disclosure;

FIG. 10 is an exemplary graphic component displaying an adjusted price in a passenger terminal according to some embodiments of the present disclosure;

FIG. 11 is an exemplary graphic component displaying an adjusted price in a passenger terminal according to some embodiments of the present disclosure;

FIG. 12 is an exemplary graphic component displaying an adjusted price in a passenger terminal according to some embodiments of the present disclosure; and

FIG. 13 is an exemplary graphic component displaying an adjusted price in a passenger terminal according to some embodiments of the present disclosure.

### DETAILED DESCRIPTION

In the following detailed description, numerous specific details are set forth by way of examples in order to provide a thorough understanding of the relevant teachings. However, it should be apparent to those skilled in the art that the present disclosure may be practiced without such details. In other instances, well known methods, procedures, systems, components, and/or circuitry have been described at a relatively high level, without detail, in order to avoid unnecessarily obscuring aspects of the present disclosure.

The present disclosure describes methods and systems for matching a service request and candidate vehicles. The methods and systems as disclosed herein aim at determining one or more candidate vehicles based on status information. The status information may include a travelling destination, an access status (i.e., availability to accept the service request) to the transportation service request, a response probability, a preference of a driver, a vehicle type, a current number of passengers in the vehicle, a maximum passenger capacity of the vehicle, a color of the vehicle, a service level of the driver, a current speed of the vehicle, or any information relative to the vehicle, or the like, or any combination thereof. The methods and systems as disclosed herein also provide ways for displaying status information and transportation service requests in a graphic view. Transportation service request may include, for example, departure information of the passenger (e.g., a pickup location), destination information of the passenger (e.g., a drop-off location), a real-time position of the passenger, a passenger identifier, a specific time of the sending of the service request, a preference of the passenger, a number of fellow passengers, or the like, or any combination thereof.

The systems and methods for matching a service request and candidate vehicles may be used in different transportation systems (transportation includes but is not limited to land transportation, sea transportation and air transportation, or the like, or a combination thereof) including, such as vehicle management system employed for taxi and limousine, intra-city express delivery system, or the like. It is understood that these exemplary applications of the system and method disclosed herein are provided for illustration purposes, and not intended to limit the scope of the present disclosure. The disclosed system and method may be applied in other contexts, e.g., other on-demand services.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

In the present disclosure, a “user,” a “passenger,” a “requester,” a “service requester,” and a “customer” are used interchangeably to refer to individuals that are requesting or ordering a service. Also, a “provider,” a “service provider,” and a “supplier” are used interchangeably to refer to an individual, an entity or a tool that may provide a service or facilitate the providing of the service. The term “party” may refer to an individual that is requesting or ordering a service, or an individual, an entity that may provide a service. The term “user terminal” in the present disclosure may refer to a tool that may be used to request a service, order a service, facilitate the requesting of the service, provide a service, or facilitate the providing of the service.

Vehicles of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for matching a service request and candidate vehicles. When a passenger terminal sends out a transportation service request, such as taxi service request, the systems and methods may identify and display positions of nearby vehicles that are available for providing the service on the passenger terminal. The systems and methods may also display positions of other nearby passenger terminals who just sent out similar service requests.

It should be noted that online on-demand transportation service, such as online taxi hailing, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Online taxi, however, allows a user of the service to real-time and automatic distribute a service request to a vast number of individual service providers (e.g., taxi) distance away from the user. It also allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system.

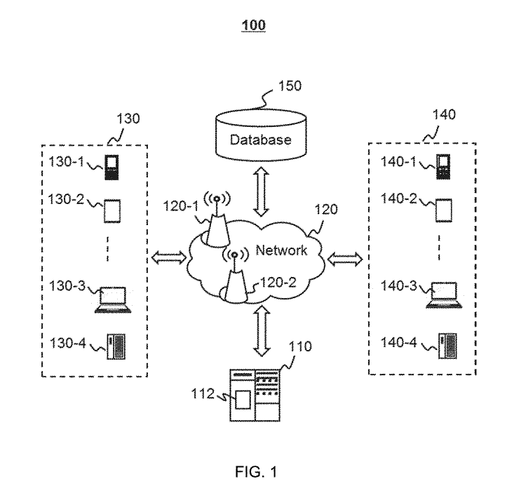

FIG. 1 is a block diagram of an exemplary on-demand service system 100 according to some embodiments of the present disclosure. For example, the on-demand service system 100 may be an online transportation service platform for transportation services such as taxi hailing, chauffeur service, express car, carpool, bus service, driver hire and shuttle service. The on-demand service system 100 may be an online platform including a server 110, a network 120, a requestor terminal 130, a provider terminal 140, and a database 150. The server 110 may include a processing engine 112.

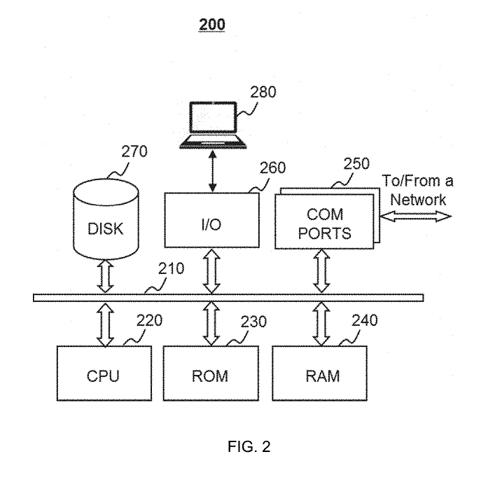

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a target vehicle based on the service request obtained from the requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 may also include an I/O component 260, supporting input/output between the computer and other components therein such as user interface elements 280. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

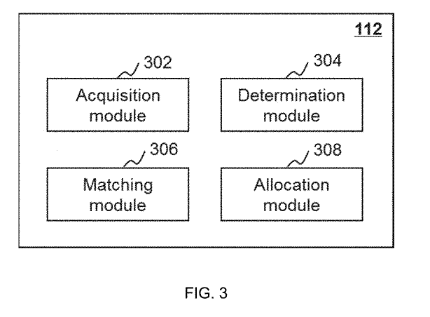

FIG. 3 is a block diagram illustrating an exemplary processing engine 112 according to some embodiments of the present disclosure. The processing engine 112 may include an acquisition module 302, a determination module 304, a matching module 306, and an allocation module 308.

The acquisition module 302 may be configured to obtain a plurality of orders from a plurality of requestors. As used herein, the system 100 may generate an order based on a request for an on-demand service sent by a requestor. It should be noted that in the disclosure there is no substantial difference between an order and a request.

The on-demand service may be a transportation service for a taxi, a private vehicle, a bus, a truck, a test drive, a designated driving, or the like, or a combination thereof. In some embodiments, the on-demand service may be any on-line service, such as booking a meal, shopping, or the like, or a combination thereof. In some embodiments, the requestor may choose whether to agree to share a service with other requestors in the on-demand service request. For example, the requestor may disagree to share a service with other requestors in any circumstances. As another example, the requestor may agree to share a service with other requestors under some situations (e.g., in traffic peak period).

The acquisition module 302 may obtain the plurality of orders from the requestor terminal 130 via the network 120. The acquisition module 302 may further obtain features (e.g., a start location, a destination) of the plurality of orders.

The determination module 304 may be configured to determine matching information of the plurality of orders based on the features. The determination module 304 may determine matching information between any two of the plurality of orders. The matching information may indicate whether the two orders may be sharable.

The matching module 306 may be configured to determine a set of sharable orders based on the matching information. As used herein, a sharable order may refer to an order that may be combined with other order(s). For example, if order A and order B include a similar start location or a similar destination, the matching module 306 may determine order A and order B as sharable orders. As used herein, a similar start location may refer to a start location of order A is reasonably close to a start location of order B for an ordinary person in the art. For example, if a distance between the start location of order A and the start location of order B is less than a threshold, such as 500 meters, 1 kilometer, or 1.5 kilometer, the system 100 may determine that the order A and order B include a similar start location. Likewise, the system may determine the similar destination in a similar way.

The allocation module 308 may allocate the set of sharable orders to providers. For example, the allocation module 308 may combine two of the set of sharable orders as an order group and allocate the order group to a provider (e.g., a driver).

The modules in the processing engine 112 may be connected to or communicate with each other via wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the acquisition module 302 may be integrated in the determination module 304 as a single module which may both obtain features of orders and determine matching information of the orders.

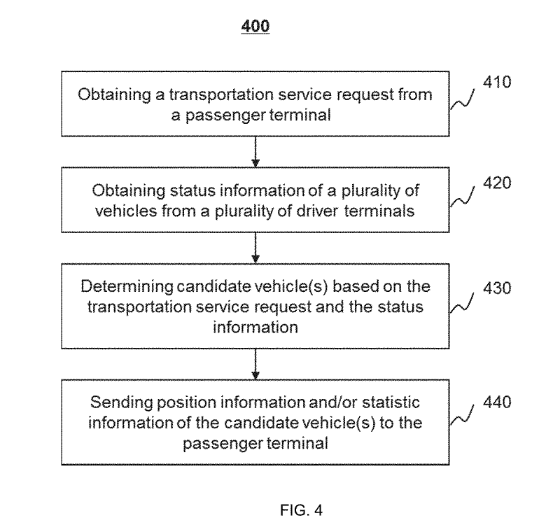

FIG. 4 is a flowchart of an exemplary method and/or process for determining candidate vehicle(s) based on a transportation service request according to some embodiments of the present disclosure. The process and/or method may be operated by a computer server (e.g., the server 110) of an online transportation service platform of the on-demand service system 100. For example, the method and/or process may be implemented as a set of instructions and stored in at least one storage medium of the online transportation service platform. At least one processor of a computer server of the platform may communicate with the storage medium and execute the set of instructions to perform the following steps.

In some embodiments, a passenger may acquire a transportation service via an online transportation service platform, such as the on-demand service system 100. The passenger may log-in the online transportation service platform through a passenger terminal (e.g., a requestor terminal 130). A driver may provide transportation service via the online transportation service platform. The driver may log-in the online transportation service platform through a driver terminal (e.g., a provider terminal 140). The driver terminal may be associated with a vehicle.

A first passenger terminal may generate and send a service request (i.e., a first service request) for a transportation service to a computer server of the online transportation service platform. The first passenger terminal may collect data relative to a passenger. For example, the first passenger terminal may collect a real-time location of the passenger. As another example, the first passenger terminal may collect the preference (e.g., a type of a vehicle) of the passenger. The first passenger terminal may determine a pickup location based on a Global Position System (GPS), a network address, a predetermined pickup location, a user input, or the like, or any combination thereof.

In step 410, a computer server (e.g., the server 110) may obtain a transportation service request (e.g., the first service request) from a passenger terminal (e.g., the first passenger terminal). In some embodiments, the transportation service request may include departure information of the passenger (e.g., a pickup location), destination information of the passenger (e.g., a drop-off location), a real-time position of the passenger, a passenger identifier, a specific time of the sending of the service request, a preference of the passenger, a number of fellow passengers, or the like, or any combination thereof.

The passenger identifier may include information relative to the passenger. The passenger identifier may be identified by the first passenger terminal thereof or the computer server of the on-demand service system 100. In some embodiments, the passenger identifier may include, a phone number, an identity (ID) number, Internet Protocol (IP) address, a media access control (MAC) address, a photo, a voice, any information that may be identified by the computer server, or the like, or any combination thereof. In some embodiments, the passenger terminal may encrypt the passenger identifier before sending it to the computer server. For example, the phone number may be encrypted as a different number, in order to protect the passenger's privacy.

In step 420, the computer server may obtain information relative to one or more vehicles and/or one or more drivers from one or more driver terminals.

In some embodiments, the computer server may obtain the information from one or more driver terminals in a first predetermined region. The first predetermined region may refer to a region centered around a specific location (e.g., a drop-off location, a pick-up location of the first passenger terminal) for a certain distance. In some embodiments, the first predetermined region may be centered on a pick-up location of the first service request. In some embodiments, the predetermined region may be centered on a drop-off location of the first service request. For example, at night, the computer server may acquire information in the first predetermined region centered on a drop-off location, in order to decide whether to adjust a service price. In some embodiments, the first predetermined region may be determined based on a location of the first passenger terminal which transmits the first service request to the computer server. The first predetermined region may be centered on the first passenger terminal. For example, after obtaining the first service request, the computer server may determine the first predetermined region as within 2 kilometers from the first passenger terminal. In some embodiments, the first predetermined region may be determined dynamically based on, at least in part, a surrounding roads and/or a surrounding traffic status of the first passenger terminal. For example, if the first passenger terminal is close to a barrier (e.g., an urban stream, or a railway) which may block the vehicle across the barrier, the first predetermined region may not include the region across the barrier. As another example, if the first passenger terminal is close to an expressway with no expressway exit, the first predetermined region may not include the region in the expressway; and the information of the vehicle(s) in the expressway may be not acquired by the computer server.

In some embodiments, the computer server may obtain the information from one or more driver terminals in a first predetermined time interval. The first predetermined time interval may include, for example, 1 minute, 5 minutes, 30 minutes, 1 hour, or any time interval before or after the first passenger terminal sending the first service request. In some embodiments, the computer server may obtain the information in real time.

The information obtained by the computer server may include status information of one or more vehicles in the first predetermined region. In some embodiments, the computer server may obtain the status information in real time. The status information may include a travelling destination, an access status (i.e., availability to accept the first service request) to the transportation service request, a response probability, a preference of a driver, a vehicle type, a current number of passengers in the vehicle, a maximum passenger capacity of the vehicle, a color of the vehicle, a service level of the driver, a current speed of the vehicle, or any information relative to the vehicle, or the like, or any combination thereof. In some embodiments, the status information may include whether the driver terminal(s) associated with the vehicle(s) are online or not, whether the driver terminal(s) are idle or not.

The travelling destination of the vehicle(s) may be preset by a driver via a driver terminal. In some embodiments, the travelling destination may vary during a car pooling. For example, a vehicle with a passenger A may have a drop-off location A, when the vehicle is shared with a passenger B, the travelling destination of the vehicle may be adjusted based on, at least in part, the drop-off location of passenger B. In some embodiments, a vehicle may have no passengers on, and the travelling destination of the vehicle may be null.

The access status to the transportation service request may include a first access status and a second access status. The first access status may mean that the driver terminal has an access to a service request, i.e., the vehicle associated with the driver terminal may be available to accept a service request. For example, the driver terminal may be in a status of receiving and responding to an order broadcasting of service requests from one or more passenger terminals. The second access status may mean that the driver terminal may have no access to a service request. For example, the driver terminal may have responded to an order and accepted the corresponding service request from a passenger terminal, thereby is not available to accept other service requests. Other example scenarios of the second access status may include when the driver terminal has an appointed order, when the driver is in a telephone conversation using the driver terminal, so that the driver terminal is unable to inform the driver about a service request, and/or when the driver terminal is in an inactive status or any status unable to respond to an order or a service request, or the like, or any combination thereof.

The response probability may refer to a probability for a driver terminal to respond to service requests that the driver received historically from the computer server. The driver terminal may determine a first number of service requests the driver terminal received and a second number of service requests the driver terminal responded in a historical time period. In some embodiments, the driver terminal or computer server may determine the response probability based on the first number and the second number. For example, the driver terminal may take the ratio of the second number and first number as the response probability. In some embodiments, the response probability may be determined by the computer server after receiving the first number and the second number from the driver terminal.

In step 430, the computer server may determine one or more candidate vehicles based on the transportation service request and/or the status information. The candidate vehicle(s) may refer to vehicle(s) available to provide the requested transportation service of the first service request.

In some embodiments, the computer server may determine one or more candidate vehicles based on a pickup location of the first service request. The computer server may determine candidate vehicle(s) within a second predetermined region around the pickup location. In some embodiments, the second predetermined region may be the same as the first predetermined region. In some embodiments, the second predetermined region may be different from the first predetermined region. For example, the second predetermined region may be smaller than the first predetermined region. In some embodiments, the computer server may determine the number of the candidate vehicle(s). In some embodiments, the number of the candidate vehicle(s) may be determined based on the number of driver terminal(s) associated with the candidate vehicle(s). For example, the computer server may count the number of driver terminal(s) within the second predetermined region (e.g., a region within 2 kilometers) around the pickup location of the first service request. The computer server may count the number of the driver terminal(s) based on, for example, a satellite map of the second predetermined region, the status information of the vehicle(s) obtained in a certain time interval, a traffic system that may detect moving vehicle(s) in real-time, or any information capable of identifying vehicle(s) or driver terminal(s) within the second predetermined region around the pickup location.

In some embodiments, the computer serer may select the candidate vehicles for the first service request based on one or more online driver terminals. An online driver terminal may refer to a driver terminal that logs in the online transportation service platform. The online driver terminal(s) may keep communication with the computer sever through a signal. The signal may include a wireless signal and/or a wired signal. In some embodiments, the online driver terminal(s) may be detected by a wireless signal. The online terminal(s) may periodically transmit a wireless signal with a certain frequency to the computer server. The wireless signal may be received by the computer server directly or by one or more base stations which may have established communication with the computer server. In some embodiments, the signal may be transmitted via the network 120. For example, the signal may be received by a router around the online driver terminals, and the router may be connected with an internet.

In some embodiments, the online driver terminals may send status information to the computer server. The computer server may detect the amount of online vehicles based on the status information. The online driver terminal(s) may include idle driver terminal(s) or non-idle driver terminal(s). The idle driver terminal(s) may be associated with empty or non-full vehicle(s) that may have capacity of providing requested transportation service. The non-idle driver terminal(s) may be associated with vehicle(s) without capacity of providing requested transportation service, for example, a full vehicle.

In some embodiments, the computer server may determine candidate vehicle(s) based on one or more factors, including, for example, a pickup location, a drop-off location, a response probability of vehicle(s), an access status of vehicle(s), a travelling destination of vehicle(s), preference of a driver, pricing factors, any information in the vehicle status information or the first service request, or the like, or any combination thereof. For example, the computer server may determine, within the second predetermined region around the pickup location, a target vehicle whose access status is the first access status and whose response probability is no less than a preset value as a candidate vehicle. As another example, the computer server may determine, within the second predetermined region around the pickup location, a target vehicle whose access status is the first access status, whose response probability is no less than a preset value, and whose travelling destination is within a third predetermined region around the drop-off location as a candidate vehicle. As still another example, the computer server or the first passenger terminal may determine a first set of vehicles, based on the pickup location, the travelling destination and the response probability; and the candidate vehicle(s) may be determined based on the first set of vehicles and a preference of the passenger, such as the type of a vehicle, the color of the vehicle, a gender of a driver, etc.

In step 440, the computer server may send position information and/or statistic information of the candidate vehicle(s) to the first passenger terminal. In some embodiments, the computer server may send the information after receiving the first service request, acquiring vehicle status information, and/or determining the number of candidate vehicle(s). The information sent to the first passenger terminal by the computer server may include, for example, the number of candidate vehicle(s), statistic information, information relating to the candidate vehicle(s), any information obtained or determined by the computer server, or the like, or any combination thereof. The information relating to the candidate vehicle(s) may include, current position(s) of the candidate vehicle(s), driver license plate(s) of the candidate vehicle(s), color(s) of the candidate vehicle(s), driver identity(identities) of the candidate vehicle(s), phone number(s) of driver(s) of the candidate vehicle(s), or the like, or any combination thereof. In some embodiments, the current position(s) of the candidate vehicle(s) may be determined based on GPS location(s).

The statistic information may include one or more of a driver rating, a driver response rate, a driver response times (e.g., a number of times that the driver accept transportation requests), time that a driver responses (e.g., the time when the driver accept a transportation service request), a driver cancellation rate after response, a distance between the first passenger terminal and a driver associated with at least one candidate vehicle, a distance between the pickup location and a driver associated with at least one candidate vehicle, an estimated time for a driver associated with at least one candidate vehicle to arrive at the pickup location, or the like, or any combination thereof.

The statistic information may include historical statistic information. The historical statistic information may be previously acquired by the computer server from one or more driver terminals. The historical statistic information may be previously stored in a storage medium of the online transportation service platform. In some embodiments, the historical statistic information of a driver terminal may be determined by the computer server based on information acquired from the driver terminal.

The driver rating may be determined by the computer server based on transportation service(s) provided by a driver. The driver rating may be presented by a number value, a letter, a color, any identification capable of expressing a level of the transportation service provided by the driver, or the like, or any combination thereof. For example, the driver rating may be expressed as A, B or C, wherein rating A may indicate that the driver is ranked within the top 30% among all drivers.

The driver response rate may be determined based on a number of received orders and a number of orders responded by a driver within a predetermined time period. For example, when the number of received orders is 100, and the number of responded orders is 60, the driver response rate may be determined as 60% by the computer server. The driver response times may refer to the response times of the driver in the predetermined time period. A high response times may indicate that the driver is experienced. The time that the driver responses may be an average time of responding to a received order within the predetermined time period. The time that the driver responses may present, in part, an evaluation of a transportation service provided by the driver. When the time that the driver responses is earlier than that of other drivers, a passenger may more likely choose the driver. The driver cancellation rate after response may be determined based on a number of responded orders that were cancelled by the driver and a number of responded orders within the predetermined time period.

The distance between the first passenger terminal and a driver may be determined by determining a distance between the first passenger terminal's location and the driver terminal's location. In some embodiments, the distance between the first passenger terminal and a driver may be determined by satellite-based GPS locations of the first passenger terminal and the driver terminal. The distance between the pickup location and a driver may be determined by the computer server in real time. The computer server may transmit the distance between the pickup location and a driver to a passenger terminal in real time.

The estimated time for a driver to arrive at the pickup location may be determined by the computer server based on a current speed of the driver and a distance between the driver and the pickup location. The estimated time may be determined based on, at least in part, a traffic status, a rush hour, or the like, or any combination thereof. For example, the estimated time may be increased in rush hours. In some embodiments, the estimated time may be determined by the computer server and expressed as a range of time (e.g., a range from 5 minutes to 15 minutes). The range of time may be determined based on an average of the estimated time for a driver within a predetermined time period.

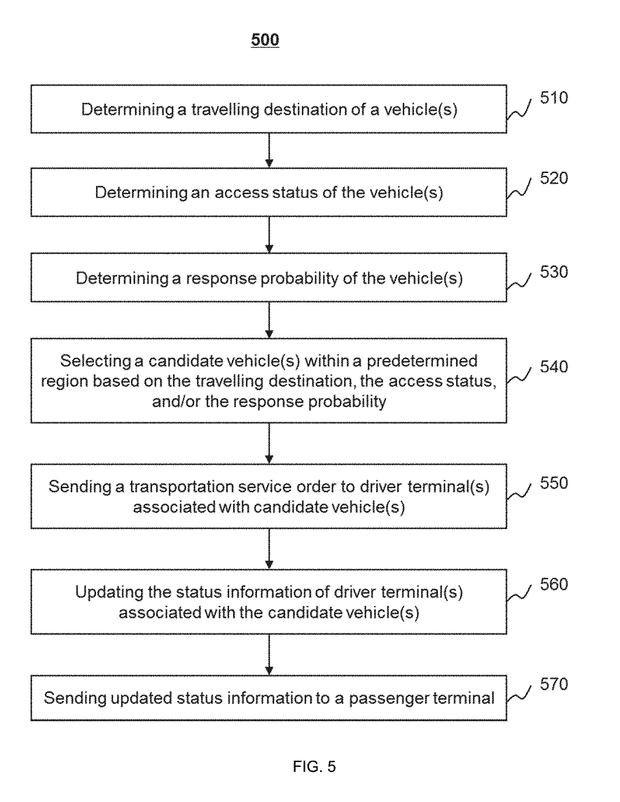

FIG. 5 is a flowchart of an exemplary method and/or process for determining candidate vehicle(s) based on a transportation service request and status information of vehicle(s) according to some embodiments of the present disclosure. The process and/or method may be operated by a computer server (e.g., the server 110) of an online transportation service platform of the on-demand service system 100. For example, the method and/or process may be implemented as a set of instructions and stored in at least one storage medium of the online transportation service platform. At least one processor of a computer server of the platform may communicate with the storage medium and execute the set of instructions to perform the following steps.

In step 510, the computer server may determine a travelling destination of vehicle(s). The travelling destination of a vehicle may be preset by a driver via a driver terminal. In some embodiments, the travelling destination may vary during a car pooling. For example, a vehicle with a passenger A may have a drop-off location A, when the vehicle is shared with a passenger B, the travelling destination of the vehicle may be adjusted based on, at least in part, the drop-off location of passenger B. In some embodiments, a vehicle may have no passengers on, and the travelling destination of the vehicle may be null.

In some embodiments, the computer server may determine the travelling destination of the vehicle(s) from the status information directly. For example, the vehicle(s) may transmit the status information including a travelling destination to the computer server; and the computer server may identify the travelling destination of the vehicle(s) from the status information directly. In some embodiments, the computer server may determine the travelling destination of the vehicle by analyzing a destination of a passenger in the vehicle. For example, the computer server may retrieve a destination from a passenger terminal associated with the passenger, which may be preset by the passenger. In some embodiments, the computer server may determine the travelling destination of the vehicle by analyzing the status information, which may include a navigation route provided by a vehicle navigation; and the destination of the navigation route may be determined as the travelling destination of the vehicle.

In step 520, the computer server may determine an access status of vehicle(s). The access status (i.e., availability to accept a service request) may include a first access status and a second access status. The first access status may mean that the driver terminal has an access to a service request, i.e., the vehicle associated with the driver terminal may be available to accept a service request. For example, the driver terminal may be in a status of receiving and responding to an order broadcasting of service requests from one or more passenger terminals. The second access status may mean that the driver terminal may have no access to a service request. For example, the driver terminal may have responded to an order and accepted the corresponding service request from a passenger terminal, thereby is not available to accept other service requests. Other example scenarios of the second access status may include when the driver terminal has an appointed order, when the driver is in a telephone conversation using the driver terminal, so that the driver terminal is unable to inform the driver about a service request, and/or when the driver terminal is in an inactive status or any status unable to respond to an order or a service request, or the like, or any combination thereof.

In some embodiments, the computer server may determine the access status by acquiring a link test signal in the status information. The link test signal may be a response to a signal that may be transmitted to the vehicle(s) by the computer server for a connection. If the computer server has received the link test signal, the access status may be the first access status; and if the computer server have not received the link test signal, the access status may be the second access status.

In some embodiments, the status information may include a routine signal transmitted by the vehicle(s) continuously to the computer server. The computer server may determine the access status by testing a presence of the routine signal. If the routine signal has been tested by the computer server, the access status may be determined as the first access status; and if the routine signal has not been tested by the computer server, the access status may be determined as the second access status.

In step 530, the computer server may determine a response probability of vehicle(s). The response probability may refer to a probability for a driver terminal to respond to service requests that the driver terminal received historically from the computer server. The driver terminal may determine a first number of service requests the driver terminal received and a second number of service requests the driver terminal responded in a historical time period. In some embodiments, the computer server may determine the response probability based on the first number and the second number. For example, the driver terminal may take the ratio of the second number and first number as the response probability. In some embodiments, the response probability may be determined by the computer server after receiving the first number and the second number from the driver terminal.

In some embodiments, the response probability may be determined based on, at least in part, a refusing probability. The refusing probability may refer to a probability for a driver terminal to refuse the service requests that the driver terminal received in a historical time period from the computer server. In some embodiments, the driver terminal may determine a third number of service requests the driver terminal received and a fourth number of service requests the driver terminal refused in a historical time period. In some embodiments, the computer server may determine the refusing probability based on the third number and the fourth number. For example, the driver terminal may take the ratio of the fourth number and third number as the refusing probability. For example, the refusing probability may be 0.1; and the response probability may be determined as no greater than 0.9.

In step 540, the computer server may select candidate vehicle(s) within a predetermined region based on the travelling destination, the access status, and/or the response probability. In some embodiments, the computer server may select candidate vehicle(s) in the first predetermined region.

In some embodiments, the computer server may determine candidate vehicle(s) based on the travelling destination of vehicle(s). The computer server may determine candidate vehicles based on the travelling destination and/or information regarding a service request (e.g., a drop-off location of the first service request). When a travelling destination of a vehicle is close to a drop-off location or a pickup location, the computer server may determine the vehicle as a candidate vehicle. In some embodiments, the computer server may determine one or more vehicles whose travelling destinations are within a third predetermined region around the drop-off location as candidate vehicles. For example, if the travelling destination of the vehicle is within 300 meters around the drop-off location, the computer server may determine the vehicle as a candidate vehicle. When a travelling destination of the vehicle is far away from the drop-off location or pickup location, the computer server may not consider the vehicle. In some embodiments, the computer server may determine a candidate vehicle solely based on the travelling destination of vehicle(s), or may use the travelling destination as one of a factor in determining a candidate vehicle.

In some embodiments, the computer server may also determine candidate vehicle(s) based on the access status of vehicle(s). The computer server may determine a target vehicle whose access status is the first access status as a candidate vehicle. When a vehicle has a second access status, the vehicle may not be determined as a candidate vehicle. In some embodiments, the computer server may exclude the vehicle(s) in the second access status when selecting candidate vehicle(s). In some embodiments, the computer server may determine candidate vehicle(s) based on both pickup location and access status. For example, the computer server may determine at least one candidate vehicle within a predetermined region (e.g., the first predetermined region) around the pickup location based on vehicle(s) in the first access status. As another example, the computer server may determine at least one candidate vehicle by excluding driver terminals in the second status from the driver terminals within the predetermined region around the pickup location. In some embodiments, the computer server may determine a candidate vehicle solely based on the access status of a vehicle, or may use the access status as one of a factor in determining a candidate vehicle.

In some embodiments, the computer server may also determine candidate vehicle(s) based on the response probability of vehicle(s). In some embodiments, the computer server may determine candidate vehicle(s) by analyzing the response probability based on a threshold. The threshold may be determined by the computer server based on a preset value, an instruction, a function, an algorithm, or a mathematic model, or the like, or any combination thereof. For example, when a response probability of a driver terminal associated with a vehicle is higher than or equal to the threshold, the computer server may determine the vehicle as a candidate vehicle; when the response probability of the driver terminal associated with the vehicle is lower than the threshold, the computer server may determine the vehicle as a non-candidate vehicle. In some embodiments, the computer server may determine one or more candidate vehicles whose response probability is larger than the threshold within a predetermined region (e.g., the first predetermined region) of the pickup location. In some embodiments, the computer server may determine a candidate vehicle solely based on the response probability of a vehicle, or may use the response probability as one of a factor in determining a candidate vehicle.

In some embodiments, the computer server may also determine candidate vehicle(s) based on a preference of a driver. The preference of a driver may be predetermined by the driver. The preference of the driver may include a gender of a passenger, a passenger rating, a number of fellow passengers, any information relative to a passenger, any information that may influence a transportation service, or the like, or any combination thereof. The computer server or the first passenger terminal may determine candidate vehicle(s) based on, at least in part, the preference of a driver. When a passenger associated with a passenger terminal that sends a service request to the computer server does not meet the preference of the driver, the computer server may not consider the vehicle associated with the driver as a candidate vehicle. In some embodiments, the computer server may determine a candidate vehicle solely based on the preference of the driver of a vehicle, or may use the preference of the driver as one of a factor in determining a candidate vehicle.

In some embodiments, the computer server may determine candidate vehicle(s) based on a pricing factor, i.e., a parameter relative to a charge set by a driver terminal for providing a service request, and/or a price option set by the first passenger terminal in the first service request. For example, the computer server may select vehicles based on the price option; and the target vehicle(s), whose corresponding parameter relative to a charge of a service request may satisfy the price option preset by the passenger, may be determined as candidate vehicle(s) by the computer server. In some embodiments, the computer server may determine a candidate vehicle solely based on the above pricing factor, or may use the pricing factor as one of a factor in determining a candidate vehicle.

In some embodiments, the computer server may determine candidate vehicle(s) based on one or more factors, including, for example, a pickup location, a drop-off location, a response probability of vehicle(s), an access status of vehicle(s), a travelling destination of vehicle(s), preference of a driver, pricing factors, any information in the vehicle status information or the first service request, or the like, or any combination thereof. For example, the computer server may determine, within the second predetermined region around the pickup location, a target vehicle whose access status is the first access status and whose response probability is no less than a preset value as a candidate vehicle. As another example, the computer server may determine, within the second predetermined region around the pickup location, a target vehicle whose access status is the first access status, whose response probability is no less than a preset value, and whose travelling destination is within a third predetermined region around the drop-off location as a candidate vehicle. As still another example, the computer server or the first passenger terminal may determine a first set of vehicles, based on the pickup location, the travelling destination and the response probability; and the candidate vehicle(s) may be determined based on the first set of vehicles and a preference of the passenger, such as the type of a vehicle, the color of the vehicle, a gender of a driver, etc.

In step 550, the computer server may send a transportation service order to driver terminal(s) associated with the candidate vehicle(s). Format of the transportation service order may include a text, an image, an audio, a video, or the like, or any combination thereof. In some embodiments, the transportation service order may be generated based on the first service request by the computer server. The transportation service order may include information of the transportation service order itself, passenger information, other information, or the like, or any combination thereof.

The information of the transportation service order itself may include a price for the transportation service, an adjusted price, a time of sending the transportation service order, a serial number of the transportation service order, a pickup location, a drop-off location, a real-time position of the passenger, a specific time of sending the first service request, a preference of the passenger, a number of fellow passengers, a pickup time, a drop-off time, a willing of sharing a car, a carriage of luggage, a mileage, an usage status of a red packet, a payment method (e.g., cash payment, card payment, on-line payment, remittance payment, etc.), a transportation service request, or the like, or any combination thereof.

The passenger information may include a passenger identifier, a real-time position of the passenger, a name, a nickname, a gender, a nationality, an age, contact information (such as a telephone number, a mobile phone number, a social-network account information (e.g., a WeChat account, a QQ account, or a LinkedIn account, etc.), a preference of the passenger, or the like, or any combination thereof. The other information may include a weather condition, an environment condition, a road condition (e.g., road closure due to security, or road work, etc.), a traffic condition, or the like, or any combination thereof.

In some embodiments, the transportation service order may include a real-time transportation service order, or a reserved transportation service order. The real-time transportation service order may be an order for starting off at a current time. The real-time transportation service order may include a pickup time, a pickup location, etc. The reserved transportation service order may be an order reserved by a passenger in a specific time or a period of time. The period of time may be a certain second, a certain minute, a certain hour, or any period of time self-defined based on a passenger's habit/preference; the period of time may also be a fixed period of time, e.g., a workday, a weekday, a holiday, a peak period, an off-peak period, etc. Correspondingly, the reserved transportation service order may include a pickup time, a pickup location, a drop-off location, etc. In some embodiments, when a time lag between the pickup time and the current time is relatively small (e.g., 1 minute), the reserved transportation service order may be configured as a real-time transportation service order.

In step 560, the computer server may update the status information of driver terminal(s) associated with candidate vehicle(s). In some embodiments, based on a driver terminal switching the first access status and/or the second access status, the computer server may update the access status of the driver terminal. For example, when a driver terminal responds to a transportation service order, the computer server may change the access status from the first access status to the second access status. As another example, when a driver terminal finishes a transportation transaction, the computer server may change the access status from the second access status to the first access status. In some embodiments, the computer server may update the travelling destination of the candidate vehicle(s) based on a current travelling destination of the candidate vehicle(s). For example, when a candidate vehicle whose travelling destination is null responds to a service request, the computer server may determine the travelling destination of the candidate vehicle as a drop-off location of the service request. In some embodiments, the computer server may update the response probability of the candidate vehicle(s). In some embodiments, the computer server may update the location information of the candidate vehicle(s). For example, the computer server may update the real-time location(s) of the candidate vehicle(s) based on GPS location(s) of the driver terminal(s) associated with the candidate vehicle(s).

In step 570, the computer server may send the updated status information to a passenger terminal (e.g., the first passenger terminal). In some embodiments, the computer server may send an updated access status of a driver terminal to the passenger terminal. For example, if the access status of the candidate vehicle is changed from the first access status to a second access status, the computer server may transmit the updated access status to the passenger terminal.

In some embodiments, the computer server may send the updated status information based on a demand of the passenger terminal. For example, if the passenger terminal sends a request for updating status information to the computer server, the computer server may transmit the updated status information to the passenger terminal. As another example, the passenger may demand the updated status information by sliding down a viewing screen of the passenger terminal, which may be displaying the status information. In some embodiments, the computer server may send a selection message for updating the status information to the passenger terminal. If the passenger terminal affirm the selection message, the computer server may send the updated status information to the passenger terminal.

When one or more drivers accept the transportation service order, the computer server may establish a transportation transaction between one of the drivers and the passenger. The first passenger terminal may display information relating to the transportation transaction. The passenger terminal may display the information in text, number, graphic view, or the like, or any combination thereof. In some embodiments, the computer server may determine an allocation code for the transportation transaction. The allocation code may be a private code consisting of a set of symbols (e.g., numbers, characters, etc.). Different transportation transactions may have different allocation codes. In some embodiments, the first passenger terminal may receive and display the allocation code from the computer server. In some embodiments, the driver terminal may receive the allocation code from the computer server. A target vehicle associated with the driver terminal may display the allocation code on the vehicle's body in a highlighted form, which may facilitate the passenger to find the target vehicle quickly.

After the passenger arriving at a drop-off location, the first passenger terminal may receive information indicating a transaction price. In some embodiments, the passenger may refuse to pay for the transaction, and the passenger terminal may send a message to the computer server to complain the transaction; and the computer server may send arbitrate information to the driver terminal and the first passenger terminal associated with the transaction. In some embodiments, the first passenger terminal may send evaluation information for the driver to the computer server. The evaluation information may be used by the computer server to determine a service level of the driver. The driver may add the passenger into a white list or a black list via the driver terminal. The white list and/or black list may be used to determine a preference of a driver. In some embodiments, the white list and/or black list may be stored in a storage medium of the driver terminal or the computer server.

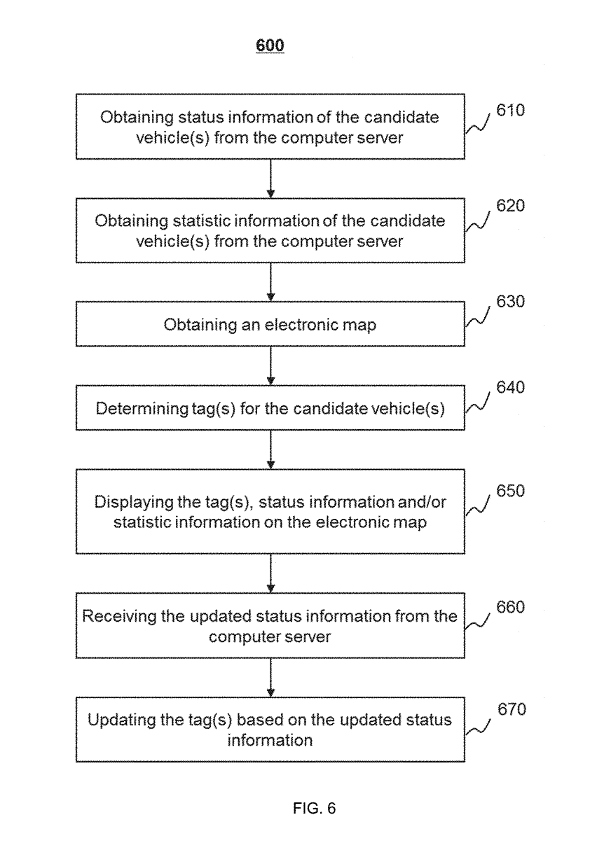

FIG. 6 is a flowchart of an exemplary method and/or process for displaying information related to candidate vehicle(s) in a user interface of a passenger terminal according to some embodiments of the present disclosure. The process and/or method may be operated by a passenger terminal (e.g., a requestor terminal 130) of an online transportation service platform of the on-demand service system 100. For example, the method and/or process may be implemented as a set of instructions and stored in at least one storage medium of the online transportation service platform. At least one processor of a passenger terminal of the platform may communicate with the storage medium and execute the set of instructions to perform the following steps.

In step 610, the passenger terminal (e.g., the first passenger terminal) may obtain status information of candidate vehicle(s) from a computer server (e.g., the server 110) or driver terminal(s) associated with the candidate vehicle(s). The status information of candidate vehicle(s) may include a travelling destination, a real-time location, an access status (i.e., availability to accept the service request) to the transportation service request, a response probability, a preference of a driver, a vehicle type, a current number of passengers in the vehicle, a maximum passenger capacity of the vehicle, a color of the vehicle, a service level of the driver, a current speed of the vehicle, or any information relative to the vehicle, or the like, or any combination thereof.

In some embodiments, the status information of candidate vehicle(s) may be obtained by the first passenger terminal via the network 120. For example, the first passenger terminal (e.g., a mobile phone) may have an access to a 4th generation mobile communication technology (4G) network; and the status information of candidate vehicle(s) may be received by the first passenger terminal in real-time. In some embodiments, the first passenger terminal may be located in a mountainous area; and the status information of candidate vehicle(s) may be received by the first passenger terminal via satellite communication (SATCOM).

In step 620, the first passenger terminal may obtain statistic information of candidate vehicle(s) from the computer server or driver terminal(s) associated with the candidate vehicle(s). The statistic information may be previously acquired by the computer server from the driver terminal(s). The statistic information may be previously stored in a storage medium of the online transportation service platform. In some embodiments, the statistic information of a driver terminal may be determined by the computer server based on information acquired from the driver terminal. The statistic information may include one or more of a driver rating, a driver response rate, a driver response times (e.g., a number of times that the driver accept transportation requests), time that a driver responses (e.g., the time when the driver accept a transportation request), a driver cancellation rate after response, a distance between the first passenger terminal and a driver, a distance between a pickup location and a driver, an estimated time for a driver to arrive at the pickup location, or the like, or any combination thereof.

In some embodiments, the statistic information of candidate vehicle(s) may be obtained by the first passenger terminal in a time interval. For example, 30 seconds after the first passenger terminal sending a transportation service request, the first passenger terminal may receive the statistic information of candidate vehicle(s) from the computer server. In some embodiments, the first passenger terminal may obtain the statistic information of candidate vehicle(s) on a demand of a passenger associated with the first passenger terminal. The demand of the passenger may be a confirmation for acquiring the statistic information.

In step 630, the first passenger terminal may obtain an electronic map. The electronic map may include a satellite map, a digital road map, a street map, a city map, a tourist map, a cartogram, a virtual map, or the like, or any combination thereof. The electronic map may be a 2D map or a 3D map. For example, the 3D map may include one or more airports with one or more terminal exports in different floors; and the passenger may identify the terminal exports clearly in the 3D map.

In some embodiments, the electronic map may be obtained from the computer server. In some embodiments, the electronic map may be stored in a memory of the first passenger terminal. For example, the electronic map may be initiated by an application installed in the first passenger terminal. In some embodiments, the electronic map be obtained through online downloading via the network 120. In some embodiments, the electronic map may be changed based on the status information or the statistic information. For example, the electronic map may be updated based on the location of candidate vehicle(s).

In step 640, the first passenger terminal may determine tag(s) for the candidate vehicle(s). The tag(s) may express information related to the candidate vehicle(s), for example, current location(s) of the candidate vehicle(s), color(s) of the candidate vehicle(s), type(s) of the candidate vehicle(s), etc. The tag(s) may be image(s), graphic logo(s) or miniature(s) of the candidate vehicles. In some embodiments, the tag(s) may be determined as one or more spots, geometric circles, geometric squares, or any visual shapes, or the like, or any combination thereof.

In some embodiments, the tags may be determined based on, at least in part, the electronic map. For example, based on the satellite map, the first passenger terminal may determine the tag(s) as the miniature(s) of the candidate vehicle(s). As another example, based on the street map, the first passenger terminal may determine the tag(s) as the graphic logo(s). In some embodiments, one or more tags may be determined for a candidate vehicle by the first passenger terminal. For example, a first tag (e.g., a geometric circle) of the candidate vehicle may be used to present a location of the candidate vehicle; and a second tag (e.g., a spot) may be used to present a current number of passengers in the candidate vehicle.

In step 650, the first passenger terminal may display the tag(s), status information and/or statistic information of the candidate vehicle(s) on the electronic map. The first passenger terminal may display the information (e.g., the status information and/or the statistic information) transmitted by the computer server. In some embodiments, the first passenger terminal may display the tag(s) determined by the first passenger terminal. The first passenger terminal may display the information in text or graphic view. In some embodiments, the computer server may receive and/or obtain location information of candidate vehicle(s) and send the location information to the first passenger terminal. The first passenger terminal may display the location(s) of the candidate vehicle(s). In some embodiments, the first passenger terminal may display one or more tags of the candidate vehicle(s) at corresponding locations in the electronic map. In some embodiments, the first passenger terminal may display dynamic moving tag(s) of the candidate vehicle(s). In some embodiments, the first passenger terminal may display a speed of a candidate vehicle or a traffic status in the electronic map. For example, when there is a traffic jam in a road, the first passenger terminal may display a different color for the road in the electronic map.

In some embodiments, the computer server may determine one or more passenger terminals associated with the transportation service requests within a third predetermined region of the first passenger terminal. The computer server may determine the real-time positions of the passenger terminals and send the positions to the first passenger terminal. The first passenger terminal may display tags of the passenger terminals in the electronic map based on the real-time positions of the passenger terminals.

In some embodiments, the first passenger terminal may display the information in text or graphic view. The first passenger terminal may present the information to a passenger through a broadcast or a Bluetooth headset. For example, the passenger terminal may broadcast a location of a candidate vehicle and an estimated time for a driver to arrive at a pickup location.

In step 660, the first passenger terminal may receive updated status information of candidate vehicle(s) from the computer server. The updated status information may include an updated travelling destination, an updated access status to the transportation service request, an updated response probability, an updated preference of a driver, an updated vehicle type, an updated current number of passengers in the vehicle, an updated maximum passenger capacity of the vehicle, an updated color of the vehicle, an updated service level of the driver, an updated current speed of the vehicle, any updated information relative to the candidate vehicle(s), or the like, or any combination thereof.

In some embodiments, the computer server may send the updated status information in real time or in a certain time interval, and the first passenger terminal may dynamically receive, store, and/or analyze the updated status information. Accordingly, if the first passenger terminal moves out of the first predetermined region, the first passenger terminal may not receive the updated status information. Accordingly, the first passenger terminal may not dynamically receive, store, and/or analyze the updated status information.

In step 670, the first passenger terminal may update the tag(s) based on the updated status information. In some embodiments, a driver terminal may update status information. For example, when a driver responds to a service request, the access status of the driver terminal may be changed from the first access status to the second access status. The updated status information may be transmitted from the driver terminal to the computer server. The vehicle associated with the driver terminal may be excluded from the candidate vehicles, and the tag of the vehicle may be changed in color, size, and/or shape, etc. For example, the computer server may determine members of the candidate vehicles in real time and the first passenger terminal may dynamically update the electronic map. Accordingly, if a candidate vehicle moves out of the first predetermined region, the computer server may remove the vehicle from being a candidate vehicle. Accordingly, the vehicle may disappears in real time from the electronic map as a candidate vehicle. When a qualified vehicle moves in the first predetermined region, the computer server may determine the vehicle as a candidate vehicle in real time, and accordingly, the vehicle may appear in real time in the electronic maps displayed by the first passenger terminal.

In some embodiments, when a candidate vehicle arrives at a pickup location, the computer server may update the location of the candidate vehicle, and the first passenger terminal may display a highlighted tag of the candidate vehicle in the electronic map, or broadcast a message to the passenger. In some embodiments, current location(s) of candidate vehicle(s) may be updated by the computer server based on satellite-based GPS location(s), and the first passenger terminal may display the tag(s) of the candidate vehicle(s) based on the dynamic location change of the candidate vehicle(s).

In some embodiments, when a driver terminal associated with a candidate vehicle has no response in a certain time period, refuses the transportation service order, or cancels the transportation service order, the computer server may transmit the updated status information to the first passenger terminal. Correspondingly the first passenger terminal may delete the tag of the candidate vehicle from the electronic map. In some embodiments, the computer server may update status information related with a number of candidate vehicles, and the first passenger terminal may correspondingly delete and/or add tags for the candidate vehicles in the electronic map.

In some embodiments, the electronic map may be updated by the first passenger terminal. For example, the computer server may determine members of the candidate vehicles in real time and the first passenger terminal may dynamically update the electronic map. Accordingly, if a candidate vehicle moves out of the first predetermined region, the computer server may remove the vehicle from being a candidate vehicle. Accordingly, the vehicle may disappears in real time from the electronic map as a candidate vehicle. When a qualified vehicle moves in the first predetermined region, the computer server may determine the vehicle as a candidate vehicle in real time, and accordingly, the vehicle may appear in real time in the electronic map displayed by the first passenger terminal.

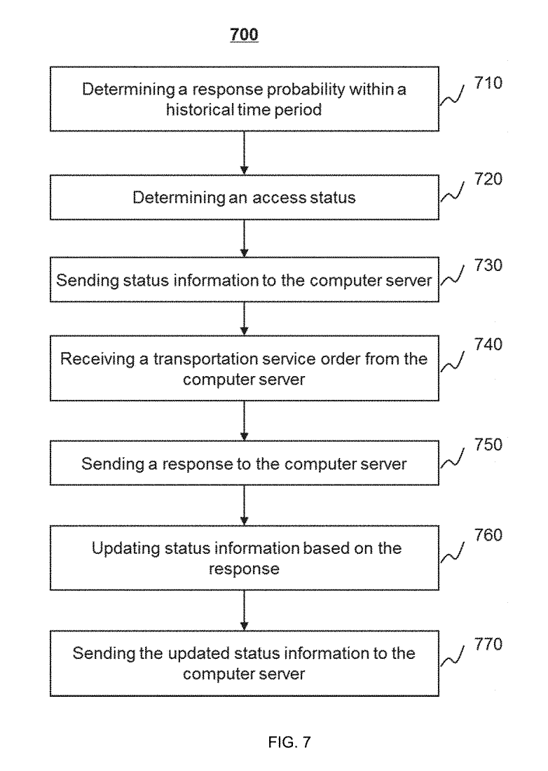

FIG. 7 is a flowchart of an exemplary method and/or process for determining status information in a driver terminal according to some embodiments of the present disclosure. The process and/or method may be operated by a driver terminal (e.g., a provider terminal 140) of an online transportation service platform of the on-demand service system 100. For example, the method and/or process may be implemented as a set of instructions and stored in at least one storage medium of the online transportation service platform. At least one processor of a provider terminal of the platform may communicate with the storage medium and execute the set of instructions to perform the following steps.

In step 710, the driver terminal may determine a response probability within a historical time period. The response probability may refer to a probability for the driver terminal to respond to service requests that the driver received historically from a computer server (e.g., the server 110). The driver terminal may determine a first number of service requests the driver terminal received and a second number of service requests the driver terminal responded in the historical time period. In some embodiments, the driver terminal may determine the response probability based on the first number and the second number. For example, the driver terminal may take the ratio of the second number and first number as the response probability. In some embodiments, the response probability may be determined by the computer server after receiving the first number and the second number from the driver terminal.

The predetermined time period may be a month, a week, a day, an hour, a half hour, etc. For example, the driver terminal may count the first number of service requests the driver terminal received and a second number of service requests the driver terminal responded by an hour. In some embodiments, the response probability may include a month response probability, a week response probability, a day response probability, an hour response probability, a half-hour response probability, or the like, or any combination thereof. For example, the driver terminal may be preset to determine both the week response probability and the hour response probability; and the computer server and/or the passenger may select the driver terminal based on, at least in part, the week response probability and the hour response probability.

In some embodiments, the driver terminal may determine the response probability according to a demand of the computer server and/or a passenger. For example, if the computer server require a specific type of the response probability, or a specific algorithm of determining the response probability, the driver terminal may use the specific algorithm to determine the specific type of the response probability, and send the response probability to the computer server.

In step 720, the driver terminal may determine an access status. The access status to the transportation service request may include a first access status and a second access status. The first access status may mean that the driver terminal has an access to a service request, i.e., the vehicle associated with the driver terminal may be available to accept a service request. For example, the driver terminal may be in a status of receiving and responding to an order broadcasting of service requests from passenger terminals. The second access status may mean that the driver terminal may have no access to a service request. For example, the driver terminal may have responded to an order and accepted the corresponding service request from a passenger terminal, thereby is not available to accept other service requests. Other example scenarios of the second access status may include when the driver terminal has an appointed order, when the driver is in a telephone conversation using the driver terminal, so that the driver terminal is unable to inform the driver about a service request, and/or when the driver terminal is in an inactive status or any status unable to respond to an order or a service request, or the like, or any combination thereof.

In some embodiments, the driver terminal may determine the access status by sending a link test signal. The link test signal may be a response to a signal that may be transmitted to the driver terminal by the computer server for a connection. If the driver terminal has transmitted the link test signal, the driver terminal may determine the access status as the first access status; if the driver terminal have not transmitted the link test signal, the driver terminal may determine the access status as the second access status.

In some embodiments, the driver terminal may determine the access status by sending a routine signal continuously. If the routine signal has been tested by the computer server, the access status may be determined as the first access status; and if the routine signal has not been tested by the computer server, the access status may be determined as the second access status.

In step 730, the driver terminal may send status information to the computer server. The status information may include a travelling destination, a real-time location, an access status (i.e., availability to accept a service request) to a transportation service request, a response probability, a preference of a driver, a vehicle type, a current number of passengers in the vehicle, a maximum passenger capacity of the vehicle, a color of the vehicle, a service level of the driver, a current speed of the vehicle, or any information relative to the vehicle, or the like, or any combination thereof.

In some embodiments, the driver terminal may send the status information in real time. For example, the driver terminal may transmit the current speed of the vehicle to the computer server in real time. In some embodiments, the driver terminal may send the status information (e.g., response probability) in a time interval (e.g., 1 hour). The driver terminal may send the status information to the computer server via the network 120. For example, the driver terminal having a connection with the computer server may send the status information via a 3G network or a 4G network.

In some embodiments, the driver terminal may compress the status information before sending it to the computer server. The compressed status information may include a lossy compressed status information or a lossless compressed status information. In some embodiments, the status information may be sent to a storage medium beyond a local region (e.g., a cloud storage) before being sent to the computer server. For example, the driver terminal may transmit the status information to the cloud storage; and the cloud storage may send the status information to the computer server. In some embodiments, the driver terminal may transmit the status information by using a broadcast, an electronic poster, an image, a laser, or the like, or any combination thereof. For example, the driver terminal may output the status information in the electronic poster that may be preset on top of the vehicle; and the status information in the electronic poster may be identified by a detector communicating with the computer server.

In step 740, the driver terminal may receive a transportation service order from the computer server. The transportation service order may include a price for the transportation service, an adjusted price, a time of sending the transportation service order, a serial number of the transportation service order, a price for the transportation service, an adjusted price, a pickup location, a drop-off location, a real-time position of the passenger, a specific time of the sending of the service request, a preference of the passenger, a number of fellow passengers, a pickup time, a drop-off time, a willing of sharing a car, a carriage of luggage, a mileage, an usage status of a red packet, a payment method (e.g., cash payment, card payment, on-line payment, remittance payment, etc.), a transportation service request, or the like, or any combination thereof.

In some embodiments, the computer server may transmit the transportation service order to one or more driver terminals associated with candidate vehicles. The driver terminal(s) may display or broadcast the order for driver(s). The driver(s) may accept, refuse, or cancel the order via the driver terminal. When a driver accepts the order, a driver terminal associated with the driver may send the accept information to the computer server. The computer server may keep the order for a predetermined time period or until receiving indication for cancelling the order from the first passenger terminal.

In some embodiments, the driver terminal may receive the transportation service order separately. For example, the driver terminal with an unstable connection with the computer server may receive a first part of the transportation service order in a first time, and receive a second part of the transportation service order in a second time. In some embodiments, the driver terminal may receive a package including the transportation service order that may be compressed or encrypted by the computer server; and the driver terminal may decompress or decrypt the package to extract the transportation service order.

In step 750, the driver terminal may send a response to the computer server. The response may include a response to accept the transportation service order, or any information from the computer server. In some embodiments, the driver terminal may receive one or more transportation service orders before sending the response. The driver may accept one or more transportation service orders. For example, the driver terminal may receive a first transportation service order and a second transportation service order; the driver may select to accept the second transportation service order and/or send the response to the computer server.

In some embodiments, the response may include a response to ignore or cancel the transportation service order. For example, if the driver does not respond to the transportation service order in a predetermined time period (e.g., 5 seconds), the driver terminal may generate a response of canceling the transportation service order, and send the response to the computer server automatically. When the driver refuses the order, or cancels the order (e.g., triggers a cancel button displayed on a driver terminal), the driver terminal may transmit corresponding information to the computer server. The driver terminal may abandon the order. The computer server may exclude the driver vehicle from candidate vehicles. In some embodiments, the computer server may update candidate vehicles, and the first passenger terminal may correspondingly delete a tag of vehicle associated with the driver on an electronic map.

In step 760, the driver terminal may update the status information based on the response. In some embodiments, the status information may be updated by the driver terminal in real time or in a certain time interval. The updated status information may include an updated travelling destination, an updated access status to the transportation service request, an updated response probability, an updated preference of a driver, an updated vehicle type, an updated current number of passengers in the vehicle, an updated maximum passenger capacity of the vehicle, an updated color of the vehicle, an updated service level of the driver, an updated current speed of the vehicle, any updated information relative to the driver terminal, or the like, or any combination thereof.

In some embodiments, the driver terminal may update the status information based on the response. For example, if the driver terminal determined a first current number of passengers; and after a certain time period, the driver terminal responds to a new transportation service order, picks up a new passenger, and/or drops off one or more passengers, the driver terminal may generate a second current number of passengers and update the status information. As another example, if the driver terminal has a null travelling destination, after the driver terminal accepts a new transportation service order, the travelling destination of the driver terminal may be updated as a drop-off location of the new transportation service order. In some embodiments, the driver terminal may update an access status of the driver terminal by switching the first access status and the second access status. For example, when the driver terminal responds to a service request, the access status may be changed from first access status to second access status. As another example, when the driver terminal finishes a transportation transaction, the access status may be changed from second access status to first access status.

In step 770, the driver terminal may send the updated status information to the computer serve. In some embodiments, the driver terminal may send the updated status information in real time. For example, the driver terminal may transmit the updated location of the vehicle to the computer server in real time. In some embodiments, the driver terminal may send the updated status information (e.g., the update response probability) in a time interval (e.g., a minute). In some embodiments, the driver terminal may send the updated status information via the network 120. For example, the driver terminal having a connection with the computer server may send the updated status information via wide area network (WAN) or virtual private network (VPN).

In some embodiments, the driver terminal may compress the updated status information before sending it to the computer server. The compressed updated status information may include a lossy compressed updated status information or a lossless compressed updated status information. In some embodiments, the updated status information may be sent to a storage beyond a local region (e.g., a cloud storage) before being sent to the computer server. For example, the driver terminal may transmit the updated status information to the cloud storage; and the cloud storage may send the updated status information to the computer server. In some embodiments, the driver terminal may transmit the updated status information by using a broadcast, an electronic poster, an image, a laser, or the like, or any combination thereof. For example, the driver terminal may output the updated status information in an electronic poster that may be preset on top of the vehicle; and the updated status information in the electronic poster may be identified by a detector communicating with the computer server.

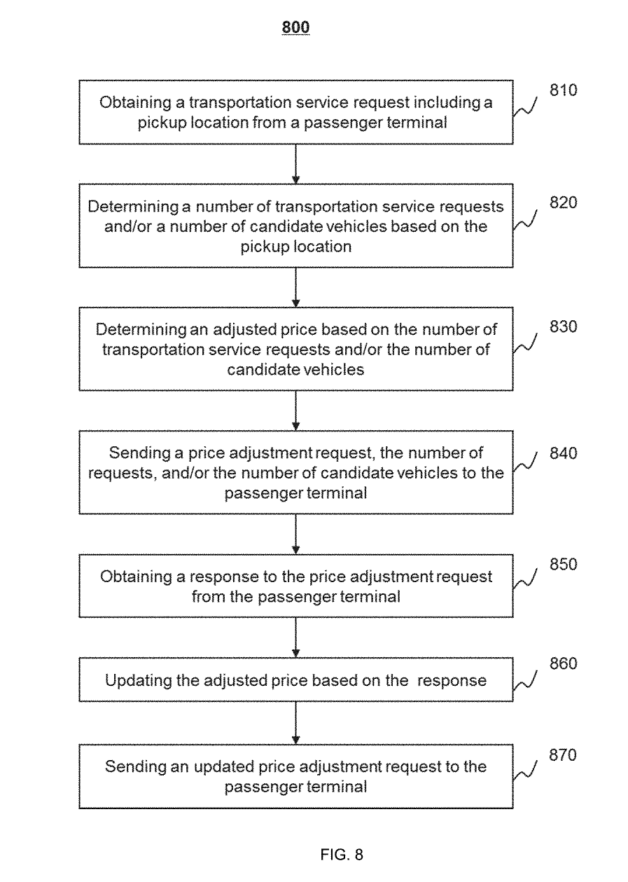

FIG. 8 is a flowchart of an exemplary method and/or process for adjusting a price for a transportation service according to some embodiments of the present disclosure. The process and/or method may be operated by a computer server (e.g., the server 110) of an online transportation service platform of the on-demand service system 100. For example, the method and/or process may be implemented as a set of instructions and stored in at least one storage medium of the online transportation service platform. At least one processor of a computer server of the platform may communicate with the storage medium and execute the set of instructions to perform the following steps.

In step 810, the computer server may obtain a transportation service request including a pickup location from a passenger terminal (e.g., the first passenger terminal).

The first passenger terminal may generate and send a service request (i.e., the first service request) for a transportation service to the computer server. The first passenger terminal may collect data relative to a passenger. For example, the first passenger terminal may collect a real-time location of the passenger. As another example, the first passenger terminal may collect the preference (e.g., a type of a vehicle) of the passenger. The first passenger terminal may determine a pickup location based on a Global Position System (GPS), a network address, a predetermined pickup location, a user input, or the like, or any combination thereof.

In some embodiments, the passenger may predetermine the pickup location based on a preference of the passenger via the first passenger terminal. For example, the predetermined pickup location may be predetermined as the passenger's home address or an address of the passenger's company. In some embodiments, the pickup location may be predetermined by a system default. For example, the pickup location may be predetermined as a passenger transportation center in a town. In some embodiments, the pickup location may include a geographic coordinate (e.g., 6.43 degrees latitude and 37.61 degrees east longitude), a street, a crossroad, a building (e.g., an underground parking garage), a station (e.g., a bus station, a railway station), or any location that may be identified by the passenger or the computer server, or the like, or any combination thereof. In some embodiments, the pickup location may be a region that may be centered around a predetermined location. For example, the pickup location may be a region centered around a shopping mall. In some embodiments, the drop-off location may be determined with the same method of the pickup location.

The computer server may obtain the first service request. The first service request may include a pickup location, a drop-off location, a passenger identifier of the first passenger terminal, a preference of the passenger, a number of fellow passengers, or the like, or any combination thereof.

In some embodiments, the computer server may update a preference of a driver. The preference of the driver may include a gender of a passenger, a passenger rating, a number of the passengers, any information related to a passenger, any information that may influence a transportation service, or the like, or any combination thereof. The computer server may update candidate vehicles based on the updated preference of the driver. In some embodiments, the computer server may transmit the updated preference of the driver to the first passenger terminal, and the passenger may update a service request based on the updated preference of the driver.

In step 820, the computer server may determine the number of transportation service requests and/or the number of candidate vehicles based on the pickup location. In some embodiments, the computer server may determine the number of the service requests in a predetermined time interval and/or a fourth predetermined region. The predetermined time interval may refer to a time interval before or after the first passenger terminal sending the first service request. The fourth predetermined region may refer to a region around the pickup location of the first service request sent by the first passenger terminal. For example, the computer server may count the number of service requests in a certain region around the pickup location of the first service request. The number of transportation service requests may refer to the number of transportation service requests sent by one or more passenger terminals (e.g., the first passenger terminal and other passenger terminals) around the pickup location of the first service request.

In some embodiments, the computer server may determine the number of the service requests based on an algorithm (e.g., a statistical algorithm). For example, the computer server may estimate the number of the service requests in the fourth predetermined region, based on a number of the service requests in a first region which may be adjacent to the fourth predetermined region. As another example, the computer server may estimate the number of the service requests in the fourth predetermined region or a predetermined time interval based on an historical average number of service requests in the same region or at the same time. In some embodiments, the computer server may determine a differential value of the number of service requests between different time intervals in the same region. For example, the computer server may determine an increment value of average number of service requests in a first time interval comparing that in a second time interval. In some embodiments, the computer server may determine the number of service requests based on, at least in part, a number of passengers that may be using a passenger terminal actively in the predetermined time interval and/or fourth predetermined region.

In some embodiments, the computer server may determine the number of the candidate vehicles based on the status information of one or more vehicles, as illustrated in step 430 and/or step 540. In some embodiments, the computer server may determine the number of the candidate vehicles for the first service request based on one or more online driver terminals. An online driver terminal may refer to a driver terminal that logs in the online transportation service platform. The online driver terminal(s) may keep communication with the computer server through a signal. The signal may include a wireless signal and/or a wired signal. In some embodiments, the online driver terminal(s) may be detected by a wireless signal. The online terminal(s) may periodically transmit a wireless signal with a certain frequency to the computer server. The wireless signal may be received by the computer server directly or by one or more base stations which may have established communication with the computer server. In some embodiments, the signal may be transmitted via the network 120. For example, the signal may be received by a router around the online driver terminals, and the router may be connected with an internet.

In some embodiments, the online driver terminals may send vehicle status information to the computer server. The computer server may determine the number of online vehicles based on the vehicle status information. The online driver terminals may include idle driver terminals or non-idle driver terminals. The idle driver terminals may be associated with empty or non-full vehicles that may have capacity of providing requested transportation service. The non-idle driver terminals may be associated with vehicles without capacity of providing requested transportation service, for example, a full vehicle. The idle driver terminals or non-idle driver terminals may be determined by a driver via the driver terminals. For example, the driver may set the driver terminal as in a non-idle status when the driver is in an emergency or the driver is unwilling to provide a transportation service.

In some embodiments, the idle driver terminals or non-idle driver terminals may be determined by the computer server based on the vehicle status information. For example, the computer server may analyze the vehicle status information (e.g., a current number of passengers in the vehicle); the current number of passengers in the vehicle may be determined based on the vehicle status information in a certain time interval; and the computer server may determine whether the driver terminal is in an idle status based on the current number of passengers in the vehicle and the maximum capacity of the vehicle. When the current number of passengers is less than the maximum capacity, the driver terminal of the vehicle may be determined as idle. In some embodiments, the computer server may select candidate vehicles based on both the online driver terminals and the idle driver terminals. That is to say, the computer server may determine vehicles associated with the online and idle driver terminals as candidate vehicles. For example, the computer server may select a first set of driver terminals according to online driver terminals; a second set of driver terminals may be determined by the computer server according to one or more idle driver terminals in the first set; and computer server may determine candidate vehicles based on the second set of driver terminals.

In step 830, the computer server may determine an adjusted price based on the number of transportation service requests and/or the number of candidate vehicles. In some embodiments, before determining the adjusted price, the computer server may determine whether the price for the transportation service is to be adjusted.

In some embodiments, the computer server may determine an adjusted price for a transportation service (e.g., the transportation service requested by the first service request). The adjusted price may refer to a raised or lowered price for the transportation service. The adjusted price may be a price, which the passenger may be willing to pay for a transportation service order, or a transportation service transaction. The adjusted price may be determined based on one or more factors, including, for example, a standard price for the transportation service, the number of transportation service requests, the number of candidate vehicles, a traffic status of a route, a current time for the transportation service (e.g., a rush hour), a vehicle restriction (e.g., odd-even number rule for vehicles), or any information capable of influencing the transportation service, or the like, or any combination thereof.

The standard price may be determined by the computer server, the first passenger terminal, or driver terminals associated with candidate vehicles. In some embodiments, the computer server may obtain parameters relative to a price determined by drivers, and/or price options for the first service request determined by the passenger. The computer server may determine the standard price by analyzing the parameters relative to a price and/or the price options. For example, the computer server may determine the standard price (e.g., a weighted average value) based on the parameters. In some embodiments, the standard price may be determined based on a regulation of an administration. In some embodiments, the standard price may be determined based on, at least in part, a reward. The reward may be determined by the online transportation service platform. In some embodiments, the standard price may be determined based on a pricing mode (e.g., a pricing mode used by taxis). For example, the computer server may determine the standard price by determining a price based on a taxi meter rule (e.g., 2 dollars per kilometer) in a current city.

The traffic status of a route may include a traffic jam, a traffic accident, a road condition of the route, or the like, or any combination thereof. For example, when an area is in a traffic jam, the computer server may raise the price for a transportation service in the area.

In some embodiments, the computer server may determine whether a price for a transportation service is to be adjusted. When the number of service requests is greater than that of candidate vehicles, the computer server may determine an adjusted price that may be higher than the standard price; when the number of service requests is less than that of candidate vehicles, the computer server may determine an adjusted price that may be lower than the standard price. In some embodiments, the computer server may determine a ratio of the number of transportation service requests and the number of candidate vehicles. When the ratio is larger than a preset threshold, the computer server may determine an adjusted price higher than the standard price for the transportation service. When the ratio is less than a preset threshold, the computer server may determine an adjusted price lower than the standard price for the transportation service.

In some embodiments, the computer server may determine the adjusted price as a number value. For example, the computer server may determine the adjusted price with an increment of 15 dollars; and a passenger may pay extra 15 dollars for a service transaction. In some embodiments, the computer server may determine a price multiplier factor that may present the times of adjusted price comparing with the standard price. For example, the computer server may determine a price multiplier factor as 1.4, when the transportation service is in a rush hour.

In some embodiments, computer server may determine the adjusted price by a bid between one or more passengers and one or more drivers via the network 120. For example, the adjusted price may be determined according to a lowest asking price. The asking price may be offered by one or more driver terminals according to the first service request.

In some embodiments, the adjusted price may be determined based on an appointment between the passenger and a driver. For example, when the passenger satisfies a transportation service provided by a driver, the passenger may be willing to offer an adjusted price that may be higher than the standard price. And the computer server may receive the adjusted price transmitted by the driver terminal associated with the driver.

In some embodiments, a driver may adjust a price based on a number of service requests via a driver terminal. For example, a driver may increase the price based on the number of service requests that the driver may consider greater than the number of candidate vehicles; and the driver terminal may transmit an adjusted price to the computer server based on the increased price. The computer server may receive the adjusted price offered by the driver terminal and inform the adjusted price to the first passenger terminal. If the passenger accepts the adjusted price, the computer server may close the deal between the passenger and the driver.

In some embodiments, the passenger may determine the adjusted price according to the number of candidate vehicles. When the passenger has waited a long time after sending the first service request, the passenger may determine an adjusted price by setting a price option with a higher price in the request, and transmit the adjusted price to the computer server in order to increase a probability for acquiring a transportation service successfully. The computer server may receive the adjusted price offered by the passenger and inform the adjusted price to nearby drivers. If a driver accepts the adjusted price, the computer server may close the deal between the passenger and the driver.

In some embodiments, the passenger and a driver may offer and counter offer their own adjusted prices back and forth to negotiate a mutually agreed price.

In step 840, the computer server may send a first price adjustment request, the number of requests, and/or the number of candidate vehicles to the first passenger terminal. The first price adjustment request may include price adjustment information, an instruction to accept or refuse the first price adjustment request, or the like, or any combination thereof. The price adjustment information may include an increment of price, a price multiplier, a decrement of price, a reason for price adjustment, or the like, or any combination thereof. The reason for price adjustment may include the number of transportation service requests, the number of candidate vehicles, a traffic status, a distance between a vehicle and the passenger, a drop-off location (e.g., a remote location), a pickup location, or the like, or any combination thereof.

In some embodiments, the computer server may send the first price adjustment request in real time. In some embodiments, the computer server may send the first price adjustment request in a time interval (e.g., a minute). In some embodiments, the computer server may send the first price adjustment request via the network 120. For example, the computer server having a connection with the passenger terminal may send the first price adjustment request via a wide area network (WAN) or a 4G network.

In step 850, the computer server may obtain a response to the first price adjustment request from the first passenger terminal. In some embodiments, the first passenger terminal may confirm the first price adjustment request. In some embodiments, the first passenger terminal may cancel the first price adjustment request. In some embodiments, the first passenger terminal may ignore the first price adjustment request. For example, the computer server may send the first price adjustment request to the first passenger terminal with a selection dialog including a confirm button, a refuse button, and/or an ignore button. If the passenger triggers the confirm button, the computer server may receive the confirmation response to the first price adjustment request. If the passenger triggers the refuse button, the computer server may obtain the refusal response to the first price adjustment request. If the passenger selects the ignore button, the computer server may obtain the ignorance response to the first price adjustment request. In some embodiments, if the passenger does not respond to the first price adjustment request, the computer server may not obtain a response from the first passenger terminal.

In step 860, the computer server may update the adjusted price based on the response. After obtaining the response to the first price adjustment request, the computer server may determine an updated adjusted price. If the computer server receives the confirmation response from the passenger terminal, the computer server may retain the adjusted price in the first price adjustment request. If the computer server obtains the refusal response from the passenger terminal, the computer server may abandon the first service request. If the computer server obtains the ignorance response or if the computer server receives no response from the first passenger terminal in a predetermined time period, the computer server may re-determine the number of transportation service requests, re-determine the number of candidate vehicles, and/or re-determine a second price adjustment request. In some embodiments, the computer server may re-determine a second price adjustment request based on, at least in part, the re-determined number of transportation service requests and/or the re-determined number of candidate vehicles. In some embodiments, before re-determining the second price adjustment request, the computer server may determine whether the price of the transportation service is to be adjusted.

In some embodiments, the computer server may update the adjusted price by generating an updated price adjustment request (e.g., the second price adjustment request). The updated price adjustment request may include, for example, updated price adjustment information, an updated instruction to accept or refuse the price adjustment request, or the like, or any combination thereof. The updated price adjustment information may include an updated increment of price, an updated price multiplier, an updated decrement of price, an updated reason for price adjustment, or the like, or any combination thereof. The reason for price adjustment may include an updated number of transportation service requests, an updated number of candidate vehicles, an updated traffic status, an updated distance between a vehicle and the passenger, an updated drop-off location (e.g., a remote location), an updated pickup location, or the like, or any combination thereof.

In step 870, the computer server may send the updated price adjustment request (e.g., the second price adjustment request) to the first passenger terminal. In some embodiments, the computer server may send an updated number of transportation service requests, and/or an updated number of candidate vehicles to the first passenger terminal. In some embodiments, the computer server may send the updated price adjustment request in real time. In some embodiments, the computer server may send the updated price adjustment request in a time interval (e.g., a minute). In some embodiments, the computer server may send the updated price adjustment request via the network 120. For example, the computer server having a connection with the first passenger terminal may send the updated price adjustment request via a wide area network (WAN) or a 3G network.

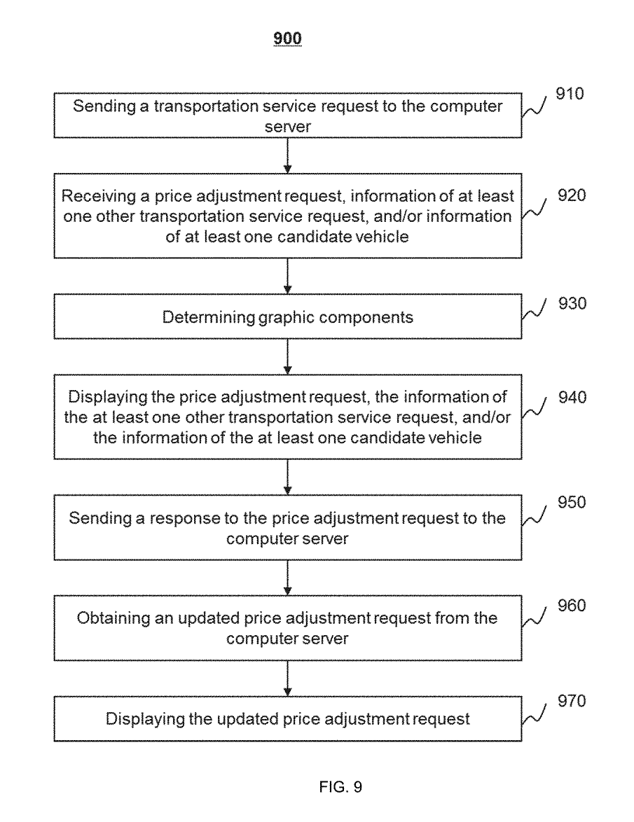

FIG. 9 is a flowchart of an exemplary method and/or process for displaying a price adjustment request (e.g., the first price adjustment request, and/or the second price adjustment request) in a passenger terminal (e.g., the first passenger terminal) according to some embodiments of the present disclosure. The process and/or method may be operated by a passenger terminal (e.g., a requestor terminal 130) of an online transportation service platform of the on-demand service system 100. For example, the method and/or process may be implemented as a set of instructions and stored in at least one storage medium of the online transportation service platform. At least one processor of a passenger terminal of the platform may communicate with the storage medium and execute the set of instructions to perform the following steps.

In step 910, the first passenger terminal may send a transportation service request (e.g., the first service request) to a computer server (e.g., the server 110). The transportation service request may include, for example, departure information of the passenger (e.g., a pickup location), destination information of the passenger (e.g., a drop-off location), a real-time position of the passenger, a passenger identifier, a specific time of the sending of the service request, a preference of the passenger, a number of fellow passengers, or the like, or any combination thereof.

In some embodiments, the passenger may update the first service request via the first passenger terminal. The passenger may change a pickup location, a drop-up location, a preference of the passenger, a number of fellow passengers, or the like, or any combination thereof, after the passenger sending the first service request to the computer server. The first passenger terminal may abandon the previous request and generate a new request, and transmit the new request to the computer server. The computer server may update information related to candidate vehicles and transportation service requests around the pickup location based on the new request. The updated information may be sent to the passenger terminal for display.

In step 920, the first passenger terminal may receive the first price adjustment request, information of at least one other transportation service request, and/or information of at least one candidate vehicle available to provide the transportation service. The first price adjustment request may include price adjustment information, an instruction to accept or refuse the price adjustment request, or the like, or any combination thereof. The first price adjustment information may include an increment of price, a price multiplier, a decrement of price, a reason for price adjustment, or the like, or any combination thereof. The reason for price adjustment may include the information of the at least one other transportation service request (e.g., a number of transportation service requests) within a predetermined region of the pickup location, the information of the at least one candidate vehicle (e.g., a number of candidate vehicles), a traffic status, a distance between a vehicle and the passenger, a drop-off location (e.g., a remote location), a pickup location, or the like, or any combination thereof.

In step 930, the first passenger terminal may determine one or more graphic components. The graphic component(s) may include text, graphic view, number, chart, diagram, or the like, or any combination thereof. In some embodiments, the graphic component(s) may be stored in a storage medium of the first passenger terminal, or obtained from the computer server. In some embodiments, the graphic component(s) may be initiated by an application installed in the first passenger terminal. In some embodiments, the graphic component(s) may include tag(s) of the candidate vehicles. The tag(s) may include image(s), graphic logo(s) or miniature(s) of the candidate vehicles. In some embodiments, the graphic component(s) may also include spot(s), geometric circle(s), geometric square(s), or any visual shape, or the like, or any combination thereof.

In some embodiments, the first passenger terminal may determine the graphic components based on the first price adjustment request, the number of service requests, and/or the number of candidate vehicles. For example, the first passenger terminal may determine a first set of graphic components based on the number of service requests. As another example, the passenger terminal may determine a second set of graphic components based on the number of candidate vehicles.

In step 940, the passenger terminal may display the first price adjustment request, the information of the at least one other transportation service request, and/or the information of the at least one candidate vehicle based on the determined graphic component(s). In some embodiments, the first passenger terminal may display the first price adjustment request in text or graphic view. For example, the first passenger terminal may display the number of transportation service requests (e.g., 1230) and the number of candidate vehicles (e.g., 820) in numbers, and the adjusted price displayed may be higher than a standard price for the transportation service. As another example, the number of transportation service requests and/or the number of candidate vehicles may be displayed by a bar chart. As still another example, an instruction to accept, refuse, or cancel the price adjustment request may be displayed as a message box, a button, or the like, or any combination thereof.

In some embodiments, the first passenger terminal may display the information in text or graphic view. In some embodiments, the first passenger terminal may present the information to a passenger through a broadcast or a Bluetooth headset. For example, the first passenger terminal may broadcast a location of a candidate vehicle and an estimated time for a driver to arrive at the pickup location. In some embodiments, the first passenger terminal may display information by a graphical user interface. The graphical user interface may facilitate the passenger to interact with the first passenger terminal. For example, the first passenger terminal may display a message interface for the passenger to input and/or select an instruction. The passenger may interact with the first passenger terminal through the message interface. The message interface may include a first message box indicating accepting the price adjustment request (e.g., a confirm button), a second message box indicating refusing the price adjustment request (e.g., a refuse button), and/or a third message box indicating ignoring the price adjustment request (e.g., an ignore button). For example, the passenger may trigger the confirm button to accept the first price adjustment request, the refuse button to refuse the first price adjustment request, and/or the ignore button to ignore the first price adjustment request.

In step 950, the first passenger terminal may send a response to the first price adjustment request to the computer server. The response to the first price adjustment request is determined based on a selection of the passenger. When the passenger accept the first price adjustment request (e.g., the first message box is triggered and/or activated), the first passenger terminal may send a confirmation response (e.g., response information indicating that the price adjustment request is accepted) to the computer server. When the passenger refuse the first price adjustment request (e.g., the second message box is triggered and/or activated), the first passenger terminal may send a refusal response (e.g., response information indicating that the price adjustment request is refused) to the computer server. When the passenger ignores the first price adjustment request (e.g., the third message box is triggered and/or activated), the first passenger terminal may send an ignorance response (e.g., response information indicating that the price adjustment request is ignored) to the computer server. In some embodiments, the passenger may not respond to the first price adjustment request, and the first passenger terminal may not send a response to the computer server.

In some embodiments, when the first passenger terminal accepts the first price adjustment request, the computer server may generate an order request based on the first service request and an adjusted price, and send the order request to one or more driver terminals associated with the candidate vehicles. When the first passenger terminal refuse the first price adjustment request, the computer server may abandon the first service request. If the first passenger terminal ignores the first price adjustment request, or if the first passenger terminal does not respond to the first price adjustment request within a predetermined time period (e.g., the first message box, the second message box, and/or the third message box is not triggered within the predetermined time period), the computer server may re-determine whether the price of the transportation service is to be adjusted, and/or update the first price adjustment request.

In step 960, the first passenger terminal may obtain an updated price adjustment request from the computer server. In some embodiments, the first passenger terminal may obtain an updated number of service requests, and/or an updated number of candidate vehicles. In some embodiments, the first passenger terminal may receive the updated price adjustment request in real time. In some embodiments, the first passenger terminal may obtain the updated price adjustment request in a time interval (e.g., a minute).

In step 970, the first passenger terminal may display the updated price adjustment request based on the determined graphic components. In some embodiments, the first passenger terminal may display an updated price. When the first passenger terminal have no response to the first price adjustment request provided by the computer server in a predetermined time period (e.g., 30 s, 60 s, 90 s, etc.), the first passenger terminal may send a request for re-determining price to the computer server. Then the computer server may re-determine a number of candidate vehicles and a number of transportation service requests. The computer server may re-determine whether to adjust a price for the transportation service based on the re-determined number of candidate vehicles and the re-determined number of transportation service requests. The computer server may determine a second adjusted price and transmit a second price adjustment request to the first passenger terminal. The first passenger terminal may display the second price adjustment request based on a text, a number, a graphic, or the like, or any combination thereof. The first passenger terminal may display an instruction to accept, refuse, or cancel the second price adjustment request. In some embodiments, the first passenger terminal may update the second adjusted price when the passenger has no response to the adjusted price in a certain time period.

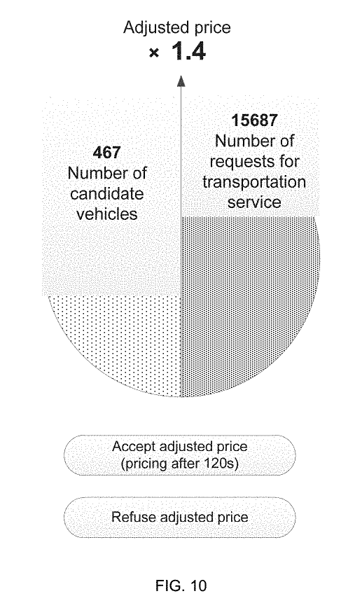

FIG. 10 is an exemplary graphic component displaying an adjusted price in a passenger terminal according to some embodiments of the present disclosure. As shown in FIG. 10, the passenger terminal may display a price multiplier (e.g., 1.4), the number of candidate vehicles (e.g., 467), and the number of transportation service request (e.g., 15687) in a pie chart. The passenger terminal may display a confirm button that instructs the passenger to respond within 120 seconds. The adjusted price may be updated if the passenger does not respond within 120 seconds. The passenger terminal may display a refuse button for refusing the adjusted price. If the passenger triggers the conformation button, the passenger terminal may send a conformation response to the computer server. If the passenger triggers the refuse button, the passenger terminal may send a refusal response to the computer server. If the passenger ignores the information more than 120 seconds, the passenger terminal may not send a response to the computer server, and the computer server may re-determine a second adjusted price.

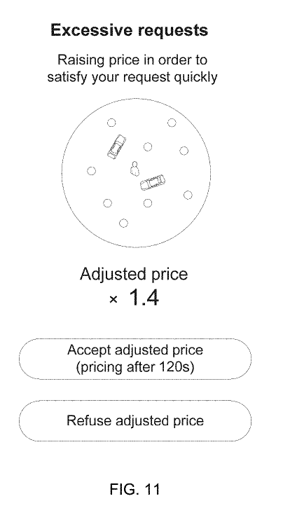

FIG. 11 is an exemplary graphic component displaying an adjusted price in a passenger terminal according to some embodiments of the present disclosure. As shown in FIG. 11, the passenger terminal may display a price multiplier (e.g., 1.4), the reason for adjusting the price (e.g., excessive requests). The passenger terminal may display a diagram illustrating tags of the service requests and the candidate vehicles. The passenger terminal may display a confirm button that instructs the passenger to respond within 120 seconds. The adjusted price may be updated if the passenger does not respond within 120 seconds. The passenger terminal may display a refuse button for refusing the adjusted price. If the passenger triggers the conformation button, the passenger terminal may send a conformation response to the computer server. If the passenger triggers the refuse button, the passenger terminal may send a refusal response to the computer server. If the passenger ignores the information more than 120 seconds, the passenger terminal may not send a response to the computer server, and the computer server may re-determine a second adjusted price.

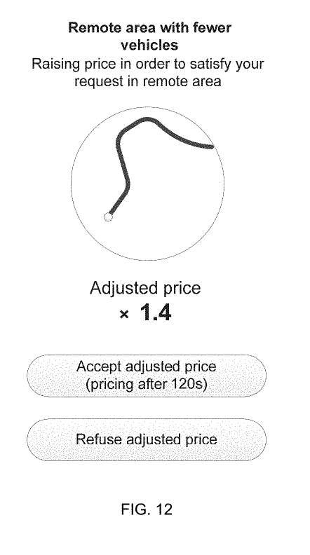

FIG. 12 is an exemplary graphic component displaying an adjusted price in a passenger terminal according to some embodiments of the present disclosure. As shown in FIG. 12, the passenger terminal may display a price multiplier (e.g., 1.4), the reason for adjusting the price (e.g., the passenger is in a remote area with fewer vehicles). The passenger terminal may display a diagram illustrating the remote area where the passenger is located and the number of candidate vehicles is small. The passenger terminal may display a confirm button that instructs the passenger to respond within 120 seconds. The adjusted price may be updated if the passenger does not respond within 120 seconds. The passenger terminal may display a refuse button for refusing the adjusted price. If the passenger triggers the conformation button, the passenger terminal may send a conformation response to the computer server. If the passenger triggers the refuse button, the passenger terminal may send a refusal response to the computer server. If the passenger ignores the information more than 120 seconds, the passenger terminal may not send a response to the computer server, and the computer server may re-determine a second adjusted price.

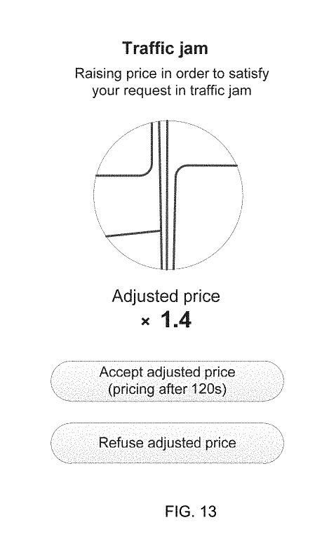

FIG. 13 is an exemplary graphic component displaying an adjusted price in a passenger terminal according to some embodiments of the present disclosure. As shown in FIG. 13, the passenger terminal may display a price multiplier (e.g., 1.4), the reason for adjusting the price (e.g., a traffic jam in rush hours). The passenger terminal may display a diagram illustrating a traffic status including the traffic jam. The passenger terminal may display a confirm button that instructs the passenger to respond within 120 seconds. The adjusted price may be updated if the passenger does not respond within 120 seconds. The passenger terminal may display a refuse button for refusing the adjusted price. If the passenger triggers the conformation button, the passenger terminal may send a conformation response to the computer server. If the passenger triggers the refuse button, the passenger terminal may send a refusal response to the computer server. If the passenger ignores the information more than 120 seconds, the passenger terminal may not send a response to the computer server, and the computer server may re-determine a second adjusted price.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system configured to provide online on-demand transportation service to users, comprising:
a bus;
a storage medium electronically connected to the bus and storing a set of instructions for monitoring a target vehicle;
logic circuits electronically connected to the storage medium, wherein when executing the set of instructions, the logic circuits are directed to conduct logic operation to:
obtain, from a first passenger terminal, a transportation service request for a transportation service including a pickup location and a drop-off location;
before selecting a vehicle to provide the transportation service:
obtain status information of a plurality of vehicles from a plurality of driver terminals within a first predetermined region around the pickup location, wherein each of the plurality of vehicles corresponds to a driver terminal of the plurality of driver terminals;
determine, from the plurality of vehicles, at least one candidate vehicle available to provide the transportation service based on the status information of the plurality of vehicles; and
send a real-time position of each of the at least one candidate vehicle to the first passenger terminal to display a tag of the at least one candidate vehicle in an electronic map on the first passenger terminal.

2. The system of claim 1, wherein the status information includes an access status to the transportation service request and a response probability.

3. The system of claim 2, wherein to determine the at least one candidate vehicle, the logic circuits further conduct logic operation to:
determine a target vehicle as the at least one candidate vehicle, wherein the access status of the target vehicle is a first access status, and the response probability of the target vehicle is no less than a preset value, wherein the first access status means the target vehicle has an access to the transportation service request.

4. The system of claim 3, wherein the status information further includes a travelling destination, and
to determine the at least one candidate vehicle, the processor is further directed to:
determine a target vehicle as the at least one candidate vehicle, wherein the travelling destination of the target vehicle is within a second predetermined region around the drop-off location.

5. The system of claim 1, wherein the logic circuits further conduct logic operation to:
send statistic information of the at least one candidate vehicle to the first passenger terminal to display the statistic information in text or graphic view on the first passenger terminal.

6. The system of claim 5, wherein the statistic information includes at least one of
a driver rating,
a driver response rate,
a driver response times,
a driver cancellation rate after response,
a distance between the first passenger terminal and a driver associated with the at least one candidate vehicle,
a distance between the pickup location and a driver associated with the at least one candidate vehicle, or
an estimated time for a driver associated with the at least one candidate vehicle to arrive at the pickup location, and
wherein the statistic information is determined within a first predetermined time period.

7. The system of claim 2, wherein the logic circuits further conduct logic operation to:
update the access status of the at least one candidate vehicle to obtain updated access status; and
send the updated access status to the first passenger terminal to display an updated tag of the at least one candidate vehicle.

8. The system of claim 1, wherein the logic circuits further conduct logic operation to:
determine a number of transportation service requests within a third predetermined region around the pickup location.

9. The system of claim 8, wherein the logic circuits further conduct logic operation to:
determine a second passenger terminal associated with one of the transportation service requests within the third predetermined region; and
send a real-time position of the second passenger terminal to the first passenger terminal to display a tag of the second passenger terminal in the electronic map on the first passenger terminal.

10. The system of claim 8, wherein the logic circuits further conduct logic operation to:
determine a number of candidate vehicles within the third predetermined region.

11. (canceled)

12. The system of claim 10, wherein the logic circuits further conduct logic operation to:
send the number of transportation service requests and the number of candidate vehicles to the first passenger terminal to display the number of transportation service requests and the number of candidate vehicles in text or graphic view on the first passenger terminal.

13. The system of claim 10, wherein the logic circuits further conduct logic operation to:
determine an adjusted price for the transportation service based on a standard price for the transportation service, the number of transportation service requests, and the number of candidate vehicles; and
send the adjusted price to the first passenger terminal.

14. A method implemented on at least one machine, each of which has at least one processor and storage for matching a transportation service request and candidate vehicles, comprising:
obtaining, from a first passenger terminal, by at least one computer server, a transportation service request for a transportation service including a pickup location and a drop-off location;
before selecting a vehicle to provide the transportation service:
obtaining, by the at least one computer server, status information of a plurality of vehicles from a plurality of driver terminals within a first predetermined region around the pickup location, wherein each of the plurality of vehicles corresponds to a driver terminal of the plurality of driver terminals;
determining, by the at least one computer server, from the plurality of vehicles, at least one candidate vehicle available to provide the transportation service based on the status information of the plurality of vehicles; and
sending, by the at least one computer server, a real-time position of each of the at least one candidate vehicle to the first passenger terminal to display a tag of the at least one candidate vehicle in an electronic map on the first passenger terminal.

15-17. (canceled)

18. The method of claim 14, further comprising:
sending, by the at least one computer server, statistic information of the at least one candidate vehicle to the first passenger terminal to display the statistic information in text or graphic view on the first passenger terminal.

19-36. (canceled)

37. A system configured to provide online on-demand transportation service to users, comprising:
a bus;
a storage medium electronically connected to the bus and storing a set of instructions for displaying information related to transportation services;
logic circuits electronically connected to the storage medium, wherein when executing the set of instructions, the logic circuits are directed to conduct logic operation to:
send a transportation service request for a transportation service including a pickup location to at least one computer server of an online transportation service platform;
receive, from the online transportation service platform, information of at least one other transportation service request within a predetermined region of the pickup location;
receive, from the online transportation service platform, information of at least one candidate vehicle available to provide the transportation service; and
display the information of the at least one other transportation service request and the information of the at least one candidate vehicle.

38. The system of claim 37, wherein the logic circuits further conduct logic operation to:
receive a price adjustment request from the online transportation service platform.

39. The system of claim 38, wherein the logic circuits further conduct logic operation to:
display the price adjustment information, and at least one of a first message box indicating accepting the price adjustment request, or a second message box indicating refusing the price adjustment request.

40. The system of claim 39, wherein the logic circuits further conduct logic operation to:
upon the first message box being triggered, send response information to the at least one computer server to accept the price adjustment; or
upon the second message box being triggered, send response information to the at least one computer server to refuse the price adjustment.

41. (canceled)

42. The system of claim 39, wherein the logic circuits further conduct logic operation to:
determine that the at least one of the first message box or the second message box is not triggered within a predetermined time period, and send a request for re-determining price for the transportation service to the at least one computer server.

43. The system of claim 37, wherein the logic circuits further conduct logic operation to:
receive a real-time position of the at least one candidate vehicle from the at least one computer server; and
display a tag of the at least one candidate vehicle in an electronic map of a passenger terminal.

44-50. (canceled)
